(19) United States
(12) Patent Application Publication
(10) Pub. No.: US 2023/0278651 A1
(43) Pub. Date: Sep. 7, 2023

(54) TRAILER FOR ELECTRIC TRUCK

(71) Applicant: Cummins Inc., Columbus, IN (US)

(72) Inventors: David P. Genter, Columbus, IN (US); John Robert Pendray, Columbus, IN (US); J. Steven Kolhouse, Columbus, IN (US); Jacob Ensign, Columbus, IN (US); Archit N. Koti, Columbus, IN (US); Nuwan Janaka Gallege, Columbus, IN (US); Aaron William Beinborn, Columbus, IN (US); Joseph P. Chandraraj, Columbus, IN (US); Bradford K.O. Palmer, Columbus, IN (US); Marco Gatti, Columbus, IN (US)

(21) Appl. No.: 18/117,229

(22) Filed: Mar. 3, 2023

Related U.S. Application Data
(60) Provisional application No. 63/316,580, filed on Mar. 4, 2022.

(51) Int. Cl. B62D 53/06; B60L 58/10; B60D 1/64; B60W 20/20; B60W 30/18

(52) U.S. Cl. CPC B62D 53/06; B60D 1/64; B60L 58/10; B60W 20/20; B60W 30/18127; B60W 2300/145

(57) ABSTRACT

A trailer arranged to be coupled to tractor unit. The tractor unit comprising an electric or hybrid electric powertrain and a control system for controlling the powertrain, wherein the trailer comprises a trailer battery and the trailer battery is arranged to provide power to the powertrain under control of the control system. The control system comprising a control module arranged to provide signals for controlling the trailer battery. The trailer battery comprising a battery management system arranged to receive the control signals and to control the trailer battery in dependence thereon.

### CROSS-REFERENCE

The present application claims priority to U.S. Provisional Application Serial No. 63/316,580, entitled “TRAILER FOR ELECTRIC TRUCK,” filed on Mar. 4, 2022, the entire disclosure of which being expressly incorporated herein by reference.

### FIELD OF THE DISCLOSURE

The present disclosure relates to a trailer for use with an electric or hybrid electric truck, and in particular a truck comprising a tractor unit for towing the trailer, and to a corresponding tractor unit.

### BACKGROUND

A truck (or lorry) is a motor vehicle designed to transport cargo. A truck may comprise a tractor unit which is designed to tow a trailer. In this case, the tractor unit provides the motive power, while the trailer carries the load. The tractor-trailer combination distributes the load across multiple axles while being more maneuverable than an equivalently sized rigid truck. Furthermore, trailers containing differing cargos can be rapidly swapped between tractor units, eliminating downtime while a trailer is unloaded or loaded.

Traditionally, tractor units use an internal combustion engine to provide the motive power. However, internal combustion engines are known to contribute to air and noise pollution. For this reason, electric and hybrid electric tractor units have been developed. Electric tractor units use one or more traction motors to provide the motive power, while hybrid electric tractor units use an internal combustion engine in combination with one or more traction motors. This can allow noise and pollution to be reduced, in comparison to traditional tractor units.

Ports are high traffic areas for marine vessels and land cargo vehicles. In many cases, high traffic/pollution areas, such as the vicinity of these ports and some city centers, are seeking to reduce air and noise pollution, and are increasingly becoming ‘geofenced’ zero emission zones. In such zones it is not always possible to keep engines running to power parts of a vehicle, including when stationary. Such regulations have therefore helped to drive the move towards the electrification of vehicles, particularly cargo vehicles.

In an electric or hybrid electric tractor unit, the traction motor is powered by a battery. The battery comprises a large number of individual electrochemical cells connected in series and parallel to achieve the total voltage and current requirements. Typically, Lithium ion (Li-ion) battery cells are used as they provide a relatively good cycle life and energy density. The battery may include a battery management system (BMS) which is responsible for monitoring and management of the battery cells.

Large and heavy duty electric and hybrid electric tractor units typically require large amounts of power from such batteries for motive power. To match the high-power needs of such vehicles, the size and bulk of on-board batteries can be significant. Batteries are often charged at the start of a journey and recharged as required. The distance an electric vehicle can travel without recharging the battery is thus inherently limited by the size of the battery. Given the spatial constraints of a typical chassis of a tractor unit, where such batteries are usually located, the amount of on-board charge that can be carried by the vehicle is limited.

Batteries provided on an external portion of the vehicle are still limited in size and capacity, and therefore there is a need for an alternative manner of providing a tractor unit with electrical power.

### SUMMARY

According to one aspect of the present disclosure there is provided a trailer arranged to be coupled to a tractor unit, the tractor unit comprising an electric or hybrid electric powertrain and a control system for controlling the powertrain, wherein the trailer comprises a trailer battery and the trailer battery is arranged to provide power to the powertrain under control of the control system, the control system comprising a control module arranged to provide signals for controlling the trailer battery and the trailer battery comprising a battery management system arranged to receive the control signals and to control the trailer battery in dependence thereon.

The present disclosure may provide the advantage that space within the trailer can be utilized to accommodate a sufficiently large battery which is able to supply the significant power requirements of an electric or hybrid electric truck, particularly in transit, carrying large loads over significant distances.

The tractor unit of a truck is complex to manufacture and expensive to purchase and maintain. Therefore, it may be desirable to avoid having to modify the inner workings of the tractor unit to increase the power onboard the truck. Trailers are also relatively simply and cheaply made when compared to the tractor unit. Modifying a trailer to accommodate a large battery is thus a desirable option over making complex and expensive modifications to other parts of the truck.

Providing the battery in the trailer may also allow the trailer to operate on its own battery power. For example, the trailer may be kept refrigerated with power from the battery, without having to rely on connectivity with or the operation of the tractor unit. This may be particularly useful when a truck comprising the trailer is required to be in an idle state or in a geo-fenced zone.

In one embodiment, the battery management system may be arranged to determine a state of charge of the trailer battery and to transmit a signal indicating a state of charge of the trailer battery to the control module, and the control module may be arranged to manage flow of power between the trailer battery and the powertrain based on the signal indicating a state of charge of the trailer battery. Managing flow of power between the trailer battery and the powertrain may comprise transmitting a signal to the battery management system by the control module.

In one embodiment, the powertrain is configured to provide regenerative power to the trailer battery under control of the control module. For example, the control system may control a flow of energy to each of a tractor battery and the trailer battery based on a desired state of charge of each battery.

In one embodiment, the trailer comprises a battery compartment and the trailer battery is housed within the battery compartment. This may allow the trailer battery to be safely packaged within the trailer.

Batteries tend to heat up during use. Thus, the battery compartment may comprise at least one air vent. This may allow cooling air to circulate through the battery compartment, in order to cool the trailer battery. Alternatively, or in addition, the trailer battery may comprise a coolant circuit through which a coolant may flow. In this case, the coolant may flow through a heat exchanger such as a radiator which is located outside the battery compartment.

In one embodiment, the trailer comprises a cargo compartment separate from the battery compartment. For example, the trailer may be a compartmentalized trailer with a battery compartment for housing the trailer battery and a separate compartment for housing cargo. This may facilitate the use of the same trailer for carrying the trailer battery and the cargo and may help with ease of packaging of the trailer battery and/or cargo. Furthermore, a trailer with a separated compartment for the trailer battery and a specific compartment for cargo may facilitate cooling of the battery and/or cargo and may help to achieve a better packaging/weight balance.

In one embodiment, the cargo compartment and the battery compartment are thermally insulated from each other. This may help to avoid heat from the trailer battery from being transferred to the cargo compartment. In this way the temperature of battery and its immediate environment will not have a significant effect on the temperature of the remainder of the trailer. Such an arrangement may be of particular importance when the remaining portion of the trailer is being kept at a specific temperature. An example of such a requirement is when the trailer is refrigerated trailer (reefer).

In one embodiment, the cargo compartment is a shipping container. Thus, the trailer may comprise a battery compartment which houses the battery and a separate portion for carrying a shipping container. This may allow a shipping container to be transported by the truck without the need to load or unload its cargo in advance.

In one embodiment, the trailer comprises a mounting arrangement for removably mounting the trailer battery within the trailer. Such a mounting arrangement may allow the battery to be integrally, but removably, provided within the trailer, such that the battery can be easily moved within or removed from the trailer. This may allow the battery to be securely mounted within the trailer and to be removed for servicing or charging, or when the trailer battery is not required.

The mounting arrangement may comprise plural complimentary portions on the trailer battery and the trailer arranged to connect securely with one another. One or all of the portions of the mounting arrangement may be integrally provided with at least one of the trailer and the battery.

In one embodiment, the trailer comprises a sensor configured to detect when the trailer battery is connected to the trailer. The sensor may be configured to provide a signal to an operator of the truck that the battery is connected. This may allow an operator of the truck to know when the battery is connected.

In one embodiment, the trailer comprises a sensor configured to monitor the condition of all or part of the battery and the mounting arrangement. The sensor may comprise a thermometer arranged to monitor the temperate of the trailer battery. Additionally or alternatively, the sensor may be arranged to detect a secure connection of the trailer battery, to the mounting system, by the mounting arrangement. Additionally or alternatively, the sensor may be arranged to determine information about the trailer battery to be passed between the battery and the trailer, the tractor unit and/or other portions of the truck of which the trailer is a part. Additionally or alternatively, the sensor may monitor a current drawn from and/or voltage of the trailer battery. The sensor may provide a fault signal if a fault is detected. A fault may be detected, for example, if the trailer battery moves, or the trailer battery temperature is too high, or if current drawn from the battery is too high, or if the battery voltage is too low or too high, or if any other fault condition is detected. The fault signal may be communicated to a user of the trailer, for example by means of a visual or audible alarm. Alternatively or in addition, the trailer may comprise battery isolation logic arranged to electrically isolate the trailer battery if a fault is detected.

In one embodiment, the trailer comprises a secondary power arrangement for providing electrical power to the trailer battery. This may allow the battery to be charged during use. The secondary power arrangement may comprise, for example, at least one of a solar panel, a generator set and a fuel cell. For example, a solar panel may be provided on the roof of the trailer for charging the trailer battery.

In one embodiment, the trailer may be configured to provide motive power as well as or instead of the tractor unit. Thus, the trailer may comprise a plurality of wheels and at least one traction motor configured to power the wheels. The traction motor in the trailer may be powered by the trailer battery. Furthermore, the traction motor in the trailer may be configured to provide regenerative power to the battery. Thus, the traction motor in the trailer may function as a generator and may use kinetic energy to generate electricity to charge the trailer battery, for example, when the truck is braking or decelerating. If desired, it may also be possible to charge the trailer battery using the traction motor in the trailer when the trailer is being pulled by the tractor unit.

The trailer may comprise a trailer control module arranged to control the trailer when the trailer is not connected to the tractor unit. The trailer battery may be used to supply power to the traction motor in the trailer under control of the control module when the trailer is operating autonomously.

If desired, the trailer battery may also be configured to provide power for other functionalities of the truck. In one embodiment, the trailer comprises a hotel module in electrical contact with the battery, wherein the hotel module is configured to provide electrical power from the battery to at least one other electrical component. Such an electrical component arranged to receive power from the battery may be comprised in a truck of which the trailer is a part, or a separate entity entirely. In one embodiment, the trailer battery is arranged to provide electrical power to at least one of an electric gate, a trailer elevator, or a cooling system. In one embodiment, the trailer is a refrigerated trailer with a cooling system, and the trailer battery is arranged to provide electrical power to the cooling system.

A trailer refrigeration unit may comprise a self-contained power source, such as a small internal combustion engine and generator (genset), for powering the refrigeration unit. In some embodiments the trailer refrigeration unit is configured to supply power, such as charging power, to the battery of the trailer. In some instances, for example during cold ambient temperatures, minimal or no additional cooling by the trailer refrigeration unit is required to maintain a cool temperature within the trailer. Surplus power of the power source of the trailer refrigeration unit can thus be used to charge the trailer battery.

The trailer battery may be in the form of one or more battery packs. The number of battery packs provided in the trailer may be varied based on the requirements of the truck, such as the functions requiring battery power or the distance to be travelled.

Improper positioning of the battery or battery packs may upset the balance of the trailer and/or the truck, potentially making it unstable. In one embodiment, the battery is provided at the front of the trailer in proximity to the tractor unit. In another embodiment, the battery may be provided at a central portion of the trailer. Additionally or alternatively, the battery may be provided at a low portion, such as the bottom, of the trailer. Where a plurality of battery packs is provided, they may be distributed through the trailer. Such positioning may help to ensure that the weight of the battery is distributed so as to minimally affect the motion and/or balance of the trailer, particularly when arranged as part of a truck.

The battery may be modular and may comprise a plurality of batteries or battery packs configurable to operate together as one whole modular battery system. At least one of the plurality of batteries/battery packs may be operable independent of the other batteries/battery packs, and/or physically separable from the modular battery system.

In some circumstances not all of the batteries will need to be in operation during operation of the trailer. Thus, it may be desirable to electrically disconnect particular batteries/battery packs from the modular battery system. Furthermore, in some circumstances, it may be desirable to remove them from the trailer altogether, without disrupting operation of the modular battery system as a whole.

In particular when the trailer is in motion, it may be difficult to identify and rectify faults within the modular battery system or within the trailer as a whole. Faulty batteries themselves or batteries in the presence of faulty parts of the trailer could in extreme situations cause fires and explosions. Further, batteries in the vicinity of leaks and trailer damage can exacerbate an already dangerous environment.

Thus it may be desirable to be able to drop, eject or otherwise remove batteries/battery packs of a modular battery system from the trailer, without affecting operation of the remaining portions of the modular battery system. This may be possible even when the trailer is in motion, so as to prevent a hazardous situation or move the trailer away from unstable batteries. Similarly, other uses of or routes undertaken by the trailer may require additional batteries/battery packs. Therefore it may be desirable to be able to connect additional batteries/battery packs to the modular battery system so as to increase battery power of the trailer itself.

The trailer may comprise a communication module arranged to communicate with the tractor unit. The communication module may enable and/or manage communication between various portions of the truck and the battery in order to control and monitor the interoperability of the battery with the truck.

The communication module may use a communication channel for transmitting signals between the communication module and another portion of the truck. The communication channel may comprise a physical cable or wire, or may be wireless.

The trailer may comprise a battery management unit for managing charge and/or discharge of the battery. The battery management unit may be for example part of a battery pack.

The trailer may be configured such that the trailer battery can be charged from an external source of power. For example, the trailer may comprise a plug or socket which allows the battery to be connected to an external electric power source. This may allow the trailer battery to be charged independently of the tractor unit. For example, the battery may be charged while the trailer is being loaded or unloaded, or while it is waiting to be used, without the need for it to be connected to the tractor unit. This may allow more efficient use of available resources, since the tractor unit is typically the most complex and expensive part of the truck.

Furthermore, the trailer battery may be charged without having to remove the battery from the trailer or requiring a person to navigate within the trailer to locate a charging port. Thus, charging the battery may be simplified and may avoid any need for the battery to be dismounted from or moved out of the trailer. This may also facilitate charging of the battery mid-journey.

According to another aspect of the present disclosure there is provided a tractor unit comprising an electric or hybrid electric powertrain and a control system for controlling the powertrain, wherein tractor unit is arranged to be connected to a trailer comprising a trailer battery, the control system comprises a control module arranged to provide signals for controlling the trailer battery, and the control module is arranged to manage flow of power between the trailer battery and the powertrain.

In one embodiment, the control module is arranged to receive a signal indicating a state of charge of the battery and to manage flow of power between the trailer battery and the powertrain based on the state of charge.

In one embodiment, the tractor unit comprises a tractor battery, and the control module is arranged to manage flow of power between the trailer battery, the tractor battery and the powertrain based on a state of charge of the trailer battery and the tractor battery.

The control module may be arranged to control a regenerative braking split between the tractor battery and the trailer battery. For example, in one embodiment the control module may determine the regenerative braking needed to maintain sufficient trailer battery capacity for a refrigeration unit, and control the regenerative braking split accordingly. In one embodiment, the control module may optimize the regenerative braking split for optimal vehicle/powertrain level operation. In one embodiment, the control module may use vehicle dynamic stability information/considerations for safely determining the split ratio limits.

In one embodiment, the control module may be arranged to perform an over the road recharging operation when there is no active braking and the trailer battery level is below a target trailer battery level. For example, when the vehicle is not braking sufficiently to maintain a desired trailer battery depletion level, the control module may demand over the road recharging. In this case the control unit may demand a negative torque on trailer motors to charge the trailer battery. This may provide a means for maintaining the trailer battery state when there is no active braking.

In one embodiment, the control module communicates with a fleet management center, for example, for updates and learning. For example, the control module may communicate current and past states to the fleet management center. The fleet management center may use the information from the truck/trailer system (and other such systems) to learn and for performance optimization. The fleet management center may send updates to the truck/trailer system for performance tuning. For example, the fleet management center may send updates to the truck/trailer system regarding commands, such as, but not limited to, distance to destination and desired depletion level of the trailer battery at destination, and refrigeration unit settings (temperature setting, humidity setting, etc).

The tractor unit may comprise a sensor configured to sense when the trailer battery is connected to the powertrain, and the control module may be arranged to manage flow of power between the trailer battery and the powertrain when it is sensed that the trailer battery is connected.

According to another aspect of the present disclosure there is provided a truck comprising a tractor unit and a trailer in any of the forms described above.

According to another aspect of the present disclosure there is provided a truck comprising a tractor unit and a trailer, wherein the tractor unit comprises an electric or hybrid electric powertrain and a control system for controlling the powertrain, the trailer comprises a trailer battery, the control system comprises a control module arranged to provide signals for controlling the trailer battery, and the control module is arranged to manage flow of power between the trailer battery and the powertrain.

The tractor unit may have a (possibly smaller) battery on board as well, and the trailer battery may provide a source of additional battery power for the truck and trailer to accommodate longer routes before recharging. This may allow the tractor unit to maneuver under its own power before picking up a charged trailer. The battery in the trailer could also be used with a diesel-powered (or other type of internal combustion engine) tractor unit that has a motor-generator on the mechanical drive transmission. This would allow some of the power to be diverted from the diesel-powered tractor unit to the battery in the trailer in order to charge the battery, and allow the battery to power the tractor unit in the case where zero-emissions are required (e.g., inside a geo-fenced port) or to supplement power from the diesel (or other internal combustion engine) to improve fuel economy.

Internal combustion engines as described herein may be compression-ignited diesel internal combustion engines or spark-ignited internal combustion engine, and may be fueled by at least one of gasoline, ethanol, methanol, hydrogen, CNG, LPG, methane, or bio-diesel fuel types.

The tractor unit may comprise a communication module arranged to be in communication with the trailer battery. This may allow the trailer battery to be operated as part of the overall powertrain of the truck.

In one embodiment, the truck comprises a coolant hose configured to circulate coolant between the tractor unit and the trailer battery. This may allow the battery and parts of the tractor unit (for example, the traction motor) to share the same coolant circuit.

In one embodiment the truck comprises a connector for removing connecting the trailer battery to the tractor unit, in particular, the tractor unit powertrain. The connector may allow the battery to be electrically connected to and disconnected from the traction motor.

The connector may be configured to provide an electrical connection and a fluid connection between the tractor unit and the trailer battery. Thus, the same connector may be used to provide both electrical and fluid connections between the battery and a part of the tractor unit such as the traction motor. The fluid connection may allow a coolant to flow as part of a cooling circuit.

The connector may comprise a locking mechanism. The locking mechanism may facilitate transfer of power from the trailer battery in a safe manner by helping to ensure that the connector is not easily disconnected. A sensor may be provided to detect when the connector is disconnected. The sensor may produce an alarm signal when the connector is disconnected. The alarm signal may cause a visual or audible alarm to be provided to an operator and/or may cause the battery to be electrically isolated from the connector.

According to another aspect of the disclosure there is provided a trailer arranged to be coupled to a tractor unit, the trailer comprising a battery within the trailer and a trailer motor arranged to provide the trailer with power. The battery may be arranged to provide power to the tractor unit when the two are coupled. Optionally the trailer comprises a landing portion arranged to be coupled to a portion of the tractor unit.

The trailer may comprise at least one of a camera, a radar and a lidar arranged for communication with the tractor unit, such that the trailer is configurable to couple with the tractor unit. The trailer may be configured to move to couple with the tractor unit under the power of the trailer motor and trailer battery. The trailer may comprise a battery unit.

The trailer battery may power functionality of the camera, radar and/or lidar of the trailer.

According to another aspect of the disclosure there is provided a tractor unit configured to couple with a trailer comprising a battery, wherein the battery is comprised within the trailer. The tractor unit may comprise at least one of a camera, radar and lidar arranged for communication with the trailer so as to facilitate coupling of the tractor unit with the trailer.

According to a further aspect of the disclosure there is provided a method of operating a truck comprising a tractor unit and a trailer, the tractor unit comprising an electric or hybrid electric powertrain and a control system for controlling the powertrain, the trailer comprising a trailer battery, and the control system comprising a control module, the method comprising providing control signals from the control module to the trailer battery to control provision of power from the trailer battery to the powertrain.

According to a further aspect of the disclosure there is provided a trailer, comprising:
a trailer battery arranged to provide power to a trailer refrigeration system; and
a battery management system arranged to receive a control signal from a temperature control unit and to control the trailer refrigeration system powered by the trailer battery;
   wherein the trailer refrigeration system has a refrigeration control unit, an electric compressor, and an inverter;
   wherein the trailer battery is arranged to provide power to the trailer refrigeration system and the refrigeration control unit is arranged to control a supply of power from the battery to the trailer refrigeration system.

The battery management system may be arranged to send a message to a vehicle computing system when the trailer battery has low power.

This aspect of the invention may be provided in combination with any of the other aspects described herein.

According to a further aspect of the disclosure there is provided a trailer, comprising:
a trailer battery arranged to provide power to an electric or hybrid electric powertrain, the trailer battery comprising a battery management system arranged to receive a control signal from a tractor unit and to control the trailer battery in dependence thereon; and
a trailer refrigeration system, the trailer refrigeration system comprising a refrigeration control unit;
   wherein the trailer battery is arranged to provide power to the trailer refrigeration system and the refrigeration control unit is arranged to control a supply of power from the battery to the trailer refrigeration system.

The trailer refrigeration system may comprise at least one of: a compressor; a condenser unit; and an evaporation unit. The compressor may be driven by a motor which may be powered by the trailer battery via (optionally) a DC-DC converter and an inverter. The refrigeration control unit may be arranged to control the inverter and/or other components of the refrigeration system such as the compressor, condenser unit and evaporation unit in order to control the temperature of the storage space.

For example, in one embodiment the refrigeration system comprises a compressor and an inverter, and the trailer battery is arranged to power the compressor via the inverter and the refrigeration control unit is arranged to control the inverter.

The trailer may be arranged to be coupled to tractor unit comprising an electric or hybrid electric powertrain and a tractor unit control system for controlling the powertrain, and the trailer battery may be arranged to provide power to the powertrain under control of the tractor unit control system, the tractor unit control system comprising a tractor unit control module arranged to provide signals for controlling the trailer battery and the trailer battery comprising a battery management system arranged to receive the control signals and to control the trailer battery in dependence thereon.

Features of one aspect of the disclosure may be provided with any other aspect. Apparatus features may be provided with method aspects and vice versa.

### BRIEF DESCRIPTION OF THE DRAWINGS

Embodiments of the present disclosure will now be described, purely by way of example, with reference to the accompanying drawings, in which:

FIG. 1 shows an overview of a truck in an embodiment of the disclosure;

FIG. 2 shows in more detail parts of the truck of FIG. 1;

FIG. 3 shows in more detail parts of a control system for the truck;

FIG. 4 shows steps taken by a control system in one embodiment of the disclosure;

FIG. 5 shows schematically a view of a truck in another embodiment of the disclosure;

FIG. 6 shows schematically a truck in another embodiment of the disclosure;

FIG. 7 shows schematically a truck in another embodiment of the disclosure;

FIG. 8 shows schematically a truck in another embodiment of the disclosure;

FIG. 9 shows schematically a truck according to another embodiment of the disclosure;

FIG. 10 shows steps carried out by a control system for alignment of a tractor unit with a trailer;

FIG. 11 shows schematically a connector;

FIG. 12 shows schematically a second view of the connector of FIG. 11;

FIG. 13 shows a truck in another embodiment of the disclosure;

FIG. 14 is a flowchart showing a process carried out by the controller one embodiment;

FIG. 15 is a flowchart showing a process 940 carried out by the controller in another embodiment;

FIG. 16 shows a flowchart of a process in another embodiment; and

FIG. 17 shows schematically a fleet management system an embodiment of the disclosure.

### DETAILED DESCRIPTION OF EMBODIMENTS OF THE DISCLOSURE

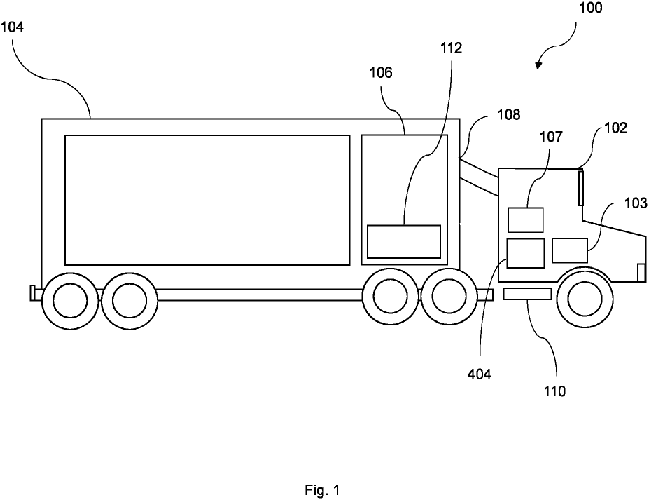

FIG. 1 shows an overview of a truck in an embodiment of the disclosure. Referring to FIG. 1, the truck 100 comprises a tractor unit 102 which provides the motive power and a trailer 104 which carries the load. The tractor unit 102 comprises a traction motor 103 which provides mechanical power to the drivetrain of the tractor unit, and a battery 110 which provides electrical power for the traction motor. The trailer 104 comprises a storage compartment or region and may include a trailer chassis. The trailer 104 may be a refrigerated trailer, or reefer, in one example.

In this example, the tractor unit 102 includes a secondary power source 404. The secondary power source may be, for example, a generator set (genset) or a fuel cell for charging the battery 110 and/or supplying power to other powertrain components. In this case, the tractor unit may be a series hybrid electric vehicle (also referred to as an extended-range electric vehicle (EREV) or range-extended electric vehicle (REEV)). Alternatively, the secondary power source could be an internal combustion engine which provides motive power to the vehicle drivetrain, which case the tractor unit may be a parallel hybrid electric vehicle. In general, the tractor unit 102 may be configured in any suitable configuration, such as series hybrid, parallel hybrid, series/parallel hybrid, fuel cell, pure electric, or any other type of powertrain with a traction motor. A control system 107 is provided for controlling the tractor unit powertrain, including the traction motor 103 and/or secondary power source 404.

In the arrangement of FIG. 1, the trailer 104 includes a battery 112 housed within a battery compartment 106. The battery 112 is electrically connected to the tractor unit by means of a connector 108. The battery 112 may be in the form of one or more battery packs, such as those disclosed in United Kingdom patent publications GB 2593187 A and GB 2594916 A, the subject matter of which is incorporated herein by reference, although other types of battery could be used instead. In operation, the battery 112 is able to provide electrical power to the traction motor 103 in the tractor unit 102.

By being provided within the trailer 104, a larger battery providing a greater energy capacity can be provided than if the battery 112 was located elsewhere on the truck, for example solely in the tractor unit 102, or underneath the trailer 104. The battery 112 will thus extend the amount of on-board battery capacity available for the truck 100 and enables the truck 100 to transport a meaningful load under battery power over a significant distance for a relatively long period of time.

Generally speaking, tractors and trailers are interchangeable with one another. It may be desirable, however, to connect tractors to appropriately ranged trailers (a trailer which can provide the required range for the journey). For example, a trailer 104 may be selected based on the primary power source of a tractor 102, capacity/charge of a tractor battery, and/or capacity/charge of the trailer battery. In another example, a tractor 102 running on hydrogen will be best paired with a trailer 104 comprising, or having capability to accommodate, a hydrogen fuel tank.

In this embodiment, the tractor unit 102 includes a tractor unit battery 110 for supplying electrical power to the traction motor 103. The tractor unit 102 is thus able to operate independently of the trailer battery 112, under its own power. For example, the tractor unit 102 may maneuver around a yard (e.g., a port location) under its own power before picking up a charged trailer or after dropping off a trailer at its destination. This independent operation of the tractor unit is particularly useful while the battery 112 is being charged, or until power from the battery 112 is otherwise used or required by the tractor unit 102. The tractor battery 110 and the trailer battery 112 may be of the same chemistry, or of different chemistries.

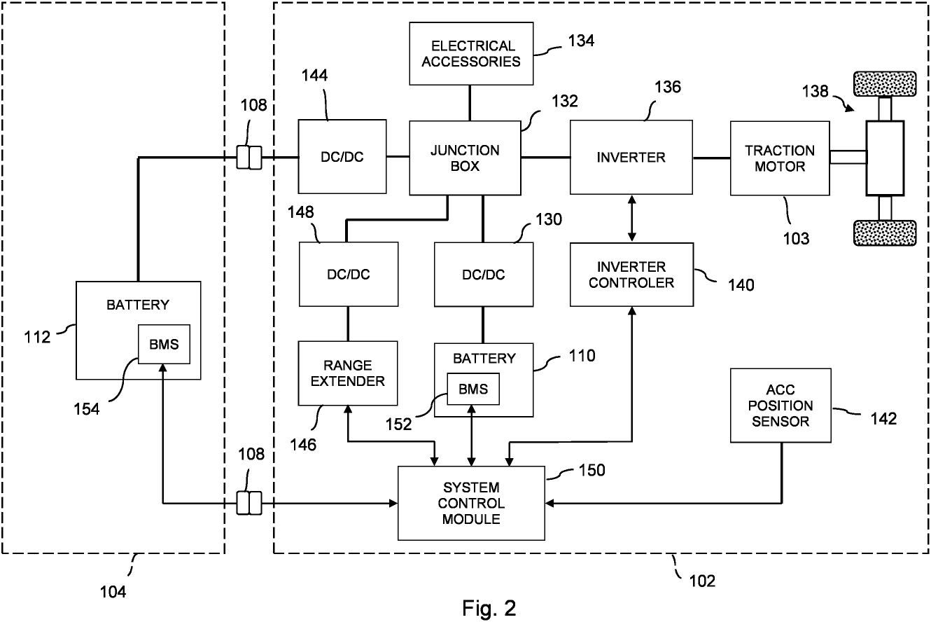

FIG. 2 shows in more detail parts of the truck of FIG. 1. Referring to FIG. 2, the truck comprises tractor unit 102 and trailer 104. The tractor unit 102 comprises tractor battery 110, first DC-to-DC converter 130, junction box 132, electrical accessories 134, inverter 136, traction motor 103, tractor drivetrain 138, inverter controller 140, accelerator pedal position sensor 142, second DC-to-DC converter 144, range extender 146, third DC-to-DC converter 148 and system control module 150. The tractor battery 110 is electrically connected to the junction box 132 via the first DC-to-DC converter 130. The junction box 132 is also electrically connected to the electrical accessories 134, inverter 136, second DC-to-DC converter 144 and third DC-to-DC converter 148. The junction box 132 is configured to provide a DC bus between the DC-to-DC converters 130, 144, 148, the inverter 136 and the electrical accessories 134. The inverter 136 is configured to convert a DC voltage on the DC bus to AC to drive the traction motor 103. The traction motor 103 is mechanically connected to the tractor drivetrain 138 and is used to propel the tractor unit. The traction motor 103 may be, for example, a permanent magnet motor, although other types of rotating electrical machine could be used instead. The traction motor 103 may also operate as a generator and may use regenerative braking to convert mechanical power from the tractor drivetrain 138 to electrical power to provide power to the components on DC bus, such as the battery 110 via DC-to-DC converter 130. In this case, the inverter 136 may be used to convert an AC output of the traction motor 103 (when operating as a generator) to DC for supply to the tractor battery 110 via the junction box 132 and the DC-to-DC converter 130. The tractor drivetrain 138 typically comprises a drive shaft and a differential connected to driven wheels, in a manner known in the art. Alternatively, the drivetrain may comprise one or more e-axles. In this case, the traction motor 103, power electronics and transmission may be combined in a unit directly powering an axle. The electrical accessories 134 may comprise components such as a heater, air conditioner, power steering inverter, compressor, fan, DC-to-DC converter, etc. The range extender 146 may be in the form of a generator set (genset) and/or a fuel cell. In the case of a generator set, the generator set may comprise an engine, a motor/generator and an inverter. The engine is typically an internal combustion engine and may run, for example on diesel, hydrogen or any other type of fuel. In the case of a fuel cell, the fuel cell is used to convert fuel in the form of hydrogen directly into electrical energy. In some embodiments, the range extender 146 and third DC-to-DC converter 148 may be omitted, in which case the truck may operate as a purely electric vehicle.

In operation, the traction motor 103 is used to supply mechanical power to the tractor drivetrain 138. Electrical power for the traction motor 103 is supplied from the tractor battery 110 via the DC-to-DC converter 130, junction box 132 and inverter 136. The inverter 136 is controlled by the inverter controller 140. The accelerator pedal position sensor 142 senses the position of the tractor unit’s accelerator pedal and provides an accelerator pedal position (APP) signal to the system control module 150. The system control module 150 calculates control signals for the inverter controller 140 to meet the driver demand power (indicated by the accelerator pedal position) within system capability. The traction motor 103 may also operate in regenerative braking mode in which the truck’s momentum is used to recover electrical energy to provide energy to the battery 110 and/or other components on DC bus. When needed, the range extender 146 is used to charge the tractor battery 110 via the DC-to-DC converter 148, junction box 132 and DC-to-DC converter 130. The tractor battery 110 may also be charged from an external power source (plugin hybrid). The tractor battery 110 includes a battery management system 152 which is used to monitor and manage charge and discharge of the tractor battery 110, under control of the system control module 150. The battery management system 152 also estimates an inner state of the tractor battery 110, such as a state of charge (SOC), which is used by the system control module 150 in the control process. The SOC provides information about the current amount of energy stored in the battery and is usually expressed as a percentage of the battery’s nominal capacity. The SOC may be estimated based on voltage and current measurements in a manner known in the art, or in any other way. The system control module 150 also controls the electrical accessories 134, via an accessories controller (not shown in FIG. 2 for simplicity). The system control module 150 is also able to control electrical accessories in the trailer 104.

In the arrangement of FIG. 2, the trailer 104 includes trailer battery 112 which is connected to the second DC-to-DC converter 144 in the tractor unit 102 by means of the connector 108. The trailer battery 112 is able to supply electrical power to the traction motor 103 and other electrical components in the tractor unit 102 via the second DC-to-DC converter 144 and the junction box 132. When the traction motor 103 is operating in regenerative braking mode, recovered electrical energy may be used to charge the trailer battery 112. The trailer battery 112 may also be charged by the range extender 146 via the DC-to-DC converter 148, junction box 132 and DC-to-DC converter 144. The trailer battery 112 includes a battery management system 154 which is used to monitor and manage charge and discharge of the trailer battery. The battery management system 154 also estimates an inner state of the battery 110, such as a state of charge (SOC).

When the trailer 104 is not connected to the tractor unit 102, each of the battery management systems 152, 154 is able to operate independently. However, when the trailer 104 is connected to the tractor unit 102, the battery management system 154 is connected via a communications link to the system control module 150. This allows the system control module 150 to control charge and discharge of the trailer battery 112 as well as the tractor battery 110. The battery management system 154 provides the SOC of the trailer battery 112 to the system control module 150 for use in the control process.

In FIG. 2, a wired connection is shown between the battery management system 154 and the system control module 150 via the connector 108. In one exemplary embodiment the connection is part of a communications network such as a Controller Area Network (CAN). However, it will be appreciated that a separate connection could be used, and any type of communications link, including wired or wireless communications links, may be used instead or as well.

When the trailer 104 is connected to the tractor unit 104, the system control module 150 manages the flow of power from the tractor battery 110, the trailer battery 112 and the range extender 146 to the traction motor 103. The system control module 150 also manages the flow of regenerative energy from the traction motor 103 (when operating as a generator) to both the tractor battery 110 and the trailer battery 112. The flow of energy to and from each of the batteries 110, 112 is determined by the desired state of charge (SOC) of each battery 110, 112.

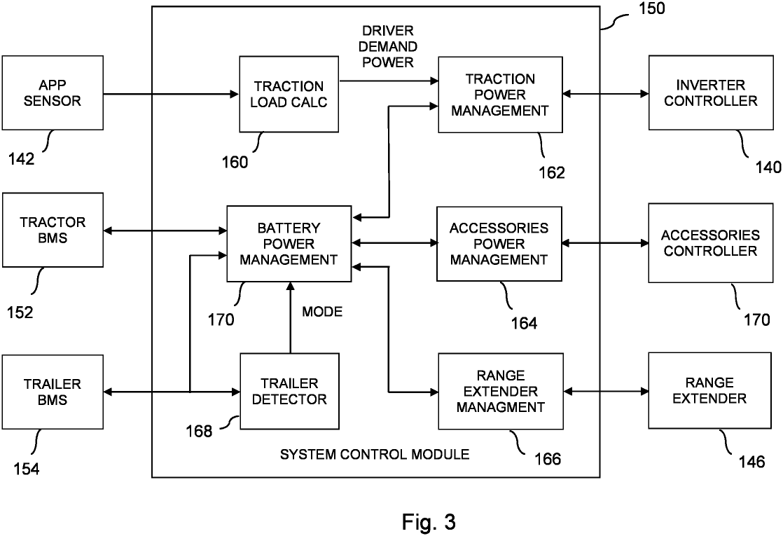

FIG. 3 shows in more detail parts of truck’s control system. Referring to FIG. 3, the control system comprises accelerator pedal position sensor 142, system control module 150, tractor battery management system 152, trailer battery management system 154, inverter controller 140 and accessories controller 170. The system control module 150 comprises traction load calculation unit 160, traction power management unit 162, accessories power management unit 164, range extender management unit 166, trailer detector 168 and battery management unit 170. The system control module 150 may be implemented as software modules running on one or more processors and/or as firmware or hardware.

In operation, the traction load calculation unit 160 receives an accelerator pedal position (APP) signal from the vehicle’s accelerator pedal. The traction load calculation unit 160 calculates a driver power demand signal based on the accelerator pedal position signal (and other signals not shown in FIG. 3). The driver power demand signal is a signal representative of the power which the driver of the truck desires from the traction motor. The driver power demand signal is fed to the traction power management unit 162. The traction power management unit 162 calculates control signals for the traction motor inverter controller 140 based on the driver power demand signal. The aim of the control is to meet the driver demand power within system capability. The output of the traction power management unit 162 is a torque control signal which is fed to the inverter controller 140 to control the torque of the traction motor.

The accessories power management unit 164 generates control signals for controlling truck accessories such as heaters, air conditions, fans, and pumps. The accessories power management unit 164 outputs control signals to the accessories controller 170. The accessories controller 170 controls the power consumption of the vehicle’s accessories, which may include accessories on the tractor unit 102 and/or the trailer 104.

The range extender management unit 166 manages operation of the range extender 146. The range extender (genset or fuel cell) is switched off when not required in order to save fuel and is switched on when needed to charge the tractor and/or trailer batteries 110, 112 or meet other power demands. When in use, the speed of operation of the genset or fuel consumed by the fuel cell is controlled to ensure efficient operation.

The trailer detector 168 communicates with the trailer battery management system 154. The trailer battery management system 154 outputs a “trailer connected” signal to the trailer detector 168 when the trailer 104 is connected to the tractor unit 102 and the trailer battery 112 is able to supply power to the DC bus. The trailer detector 168 detects whether or not the trailer 104 is connected based on the trailer connected signal. Alternatively, the trailer detector 168 may detect a physical connection or an electrical connection between the trailer 104 and the tractor unit 102, or may detect the presence of the trailer 104 using an optical sensor, or may sense the status of an input device such as a switch operated by the driver, or may detect the presence of the trailer 104 in any other way. The trailer detector 168 outputs a mode signal indicating whether the control system should operate in a tractor only mode or a tractor/trailer mode, in dependence on whether the trailer 104 is determined to be present. The mode signal is fed to the battery power management unit 170.

The battery power management unit 170 receives signals from the traction power management unit 162 and the accessories power management unit 164 indicating the power demand of the traction motor 103 and the electrical accessories 134 respectively. The battery power management unit 170 also receives the mode signal from the trailer detector 166. When the system is in tractor only mode, the tractor unit’s power demand is met by the tractor battery 110 and/or the range extender 146 only. However, when the system is in tractor/trailer mode, the battery power management unit 170 manages the flow of power from the tractor battery 110, the trailer battery 112 and the range extender 146, and the flow of regenerative power to the tractor battery 110 and the trailer battery 112. This is achieved by sending control signals from the battery power management unit 170 to the tractor battery management system 152 and the trailer battery management system 154 to control the discharge and charge of the batteries 110, 112, and control signals to the range extender management unit 166 to manage the power provided by the range extender 146. The battery power management unit 170 receives a state of charge (SOC) signal from both the tractor battery management system 152 and the trailer battery management system 154. The flow of energy from and to the batteries 110, 112 is determined by the desired SOC of each battery.

For example, when the system is in tractor/trailer mode, the battery power management system 170 may give priority to the tractor battery 110 during regenerative braking with the aim of ensuring that the tractor battery 110 remains above a predetermined SOC (for example, 80%). This helps to ensure that the tractor unit 102 is always capable of independent operation should it be needed. However, when the tractor battery 110 is above thepredetermined SOC, regenerative braking is used to charge the trailer battery 112. By having the additional battery 112 in the trailer 104, the system is able to harvest more of the regenerative energy available, thereby helping to optimize route duration. As an example, if a downhill event is imminent and the tractor battery 110 is full of charge, the energy can still be harvested by the trailer battery 112 thus ensuring that the energy recovery opportunity is not wasted. In general, the flow of electrical energy to and from the tractor battery 110 and the trailer battery 112 and from the range extender 146 is controlled in order to maximize route duration and energy efficiency.

Providing a battery in the trailer 104 in the way described above can allow the truck 100 to go further on a charge of fuel for the range extender (whether internal combustion engine or fuel cell), particularly in the case of hydrogen powered systems. In general, the range of a hydrogen powered engine system is much shorter than a diesel system since less on-board fuel can be stored. Therefore, diverting as much energy as possible to the batteries 110, 112 allows a given amount of on-board hydrogen to go as long as possible between refueling events.

In general, a proton exchange membrane (PEM) fuel cell must be accompanied by an energy storage device (e.g., battery) to be practically integrated into a mobile application to manage transient response events and fuel cell life requirements. Hydrogen powered internal combustion engines will have also have transient response challenges if not accompanied with a battery. Hydrogen is also much less energy dense than diesel fuel, so the amount of on-board hydrogen fuel is inherently compromised (compared to diesel) limiting route duration. Therefore, allowing power to be diverted to the battery will prolong the duration of a run between refueling events by minimizing the rate at which hydrogen is burned.

In the case of hydrogen internal combustion engines (ICEs), to compensate for the lower energy density of hydrogen compared to other fuels, large quantities of hydrogen may be required to complete long or otherwise energy intensive journeys. Hydrogen cylinders may be provided within the trailer 104, configurable to pass hydrogen to the tractor 102 as required. It is particularly advantageous for a hydrogen cylinder to be provided at the front of the trailer 104 so as to be adjacent to the tractor engine. Positioning hydrogen cylinders within close proximity of the tractor in this way may provide a more efficient and safe hydrogen-powered tractor-trailer system.

It can be cumbersome and time-consuming to refill empty hydrogen tanks within the trailer 104. Instead, it may be more efficient to switch empty hydrogen tanks for already filled tanks. A hydrogen tank and/or trailer 104 may include quick swap means, so as to facilitate swinging hydrogen tanks in and out of the trailer. This can minimize the downtime between refueling events. The quick-swap means may comprise mechanical and/or electrical components.

“Look ahead” and “driver learning” technology benefit usage and regeneration of batteries in trailers. The battery management system 152 may be configurable to receive information relating to a route intended for the trailer 104. Such information may relate to traffic, terrain, weather, duration, steepness etc. of the route. The battery management system 125 may be configurable to receive load information, for example its weight, storage requirements, predicted positioning within the trailer 104, etc. Using such information, the battery management system 152 may manage usage of at least one of the batteries 110, 112. The battery management system 152 may, for example, determine when to use power from the trailer battery 112, regenerate the trailer battery 112 or rely on a tractor battery 110 for power.

In an example, the battery management system 152, may receive route information for the trailer 104, and determine that the trailer 104 will travel over hills and contours. A boost in power will be required to climb such hills and the battery management system 152 may reserve power from the trailer battery 112 to provide this power as the trailer travels over the hills. Conversely, when the battery management system determines that the vehicle will be traveling downhill along a route it may be able to make use of gravity and may conserve trailer battery power for use further along the route.

“Look ahead” technology may form part of or be in communication with a fleet management system or the like. When a trailer is connected to a fleet management system, the fleet management system may itself be configured to receive SOC information relating to the batteries 110, 112. The fleet management system may monitor battery SOC, predict trailer loads based on scheduled jobs, manage power requirements of the load such as temperature regulation within the trailer, or route information/conditions.

Through “look ahead” technology and “driver learning”, regeneration events are somewhat predictable. When coming up to such an event, the SOC of the batteries 110, 112 may be monitored and controlled to ensure that there is sufficient depletion in the batteries 110, 112 to completely harvest the upcoming regenerative energy. The ability to harvest energy is a function of how much battery capacity is on-board and the type of battery used. Therefore, by adding a supplementary battery to the system, the opportunity to harvest more regenerative energy exists. The supplementary battery in the trailer may be of the same chemistry as that in the tractor unit, or of a different chemistry.

When substantial regeneration of the tractor battery 110 is possible, the power tractor batteries 110 may be sufficient to last a whole journey involving the trailer. However, in instances where regeneration during the journey will not be sufficient, a larger or more trailer batteries 112 will be needed to supply supplemental power, for example during a long haul journey.

To ensure the tractor unit 102 also has some ability to power the system in electric vehicle (EV) only mode, there must be sufficient SOC and capacity in the tractor battery 110 to ensure a specific longevity of battery only operation when crossing a geofenced boundary. In this instance, there may be cases where charging of the tractor battery 110 should be prioritized to have a certain level of SOC. On the other hand, there may be times when the trailer battery 112 is prioritized. For example, in the case of a refrigerated trailer (reefer) the trailer battery 112 might be prioritized where a full charge is needed before pulling into a truck stop. Thus, the battery power management system 170 may receive an input from the user indicating which battery is to be prioritized. If desired, the trailer battery 112 could be used to charge the tractor battery 110 up to a desired minimum SOC, or vice versa.

In general, the system control module 150 within the tractor unit 102 determines how to bias the energy harvested, and how the energy is distributed to the system including: when the fuel cell (or other power source) will provide power to the DC bus; when the fuel cell (or other power source) will charge the tractor battery 110; when the fuel cell (or other power source) will charge the trailer battery 112; when the tractor battery 110 and the trailer battery 112 is recharged during a regenerative event; when the fuel cell and the tractor battery 110 and/or the trailer battery 112 provide power to the DC bus; and so forth.

In the arrangements described above, each of the tractor battery 110 and the trailer battery 112 comprises a cooling system for thermal management. The cooling system may comprise, for example, a pump for pumping coolant through cooling plates in the battery and/or one or more fans. If desired, the tractor battery 110 and the trailer battery 112 may share the same coolant circuit. Alternatively, or in addition, any other type of cooling system, such as air cooling, liquid cooling, direct refrigerant cooling, phase change material cooling, thermoelectric cooling, or heat pipe cooling could be used. Furthermore, either or both of the tractor battery 110 and the trailer battery 112 may include a battery heating system.

In alternative embodiments, a motor/generator could be located on the wheels (or axle) or as a small power take off (PTO) element connected to an automated manual transmission (e.g., mild hybrid).

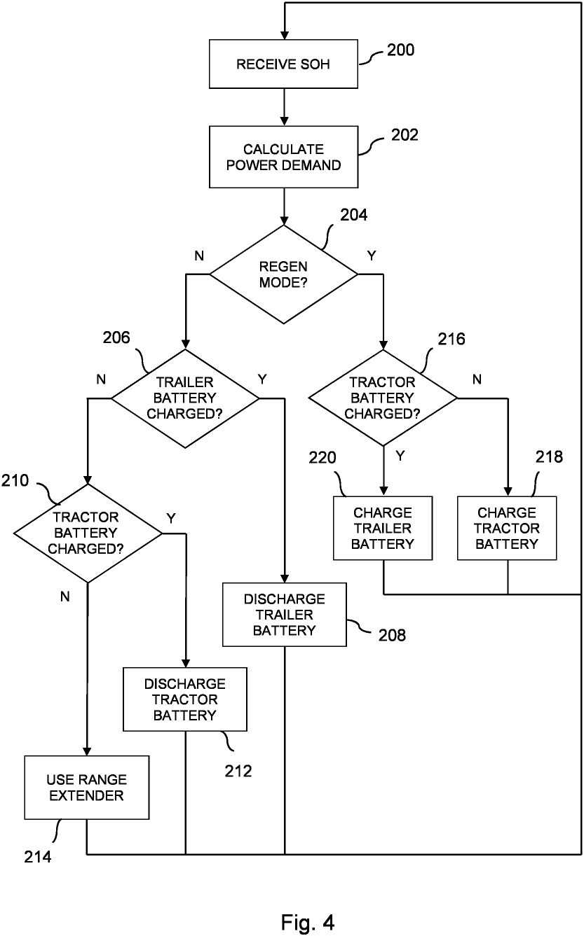

FIG. 4 is a flow chart showing steps taken by a control system in one embodiment of the disclosure. The control system may comprise the system control module described above with reference to FIGS. 1 to 3. Referring to FIG. 4, in step 200 the control system receives the SOC of the tractor battery from the tractor battery management system and the SOC of the trailer battery from the trailer battery management system. In step 202 the control system calculates the electrical power demand of the tractor unit. This is achieved by determining the total power demand of the traction motor and the electrical accessories, based on signals received from the traction power management unit and the accessories power management unit.

In step 204 it is determined whether the system is in regenerative mode. This may be achieved by determining whether the power demand is negative, indicating that the traction motor is generating regenerative power, for example because the truck is decelerating, braking or going downhill. If the system is in regenerative mode, then processing proceeds to step 216. If on the other hand the system is not in regenerative mode, then processing proceeds to step 206.

In step 206 it is determined whether the trailer battery is sufficiently charged to be able to meet the power demand and to avoid discharging the trailer battery below a desired SOC. If it is determined that the trailer battery is sufficiently charged, then in step 208 the trailer battery is discharged to the DC bus to meet the power demand. Processing then returns to step 200. If on the other hand it is determined in step 206 that the trailer battery is not sufficiently charged, then processing proceeds to step 210.

In step 210 it is determined whether the tractor battery is sufficiently charged to be able to meet the power demand and to avoid discharging the tractor battery below a desired SOC. If it is determined that the tractor battery is sufficiently charged, then in step 212 the tractor battery is discharged to the DC bus to meet the power demand. Processing then returns to step 200. If on the other hand it is determined in step 210 that the tractor battery is not sufficiently charged, then in step 214 the range extender is used. This may involve scheduling the range extender to charge the tractor battery and/or the trailer battery to a desired SOC and/or to help meet the tractor unit power demand. Processing then returns to step 200.

It will be appreciated that, depending on the circumstances, two or more of the tractor battery, the trailer battery, and the ranger extender may be used to supply electrical power, for example, during transient events or when there is a large power demand.

If the system is in regenerative mode, then in step 216 it is determined whether the tractor battery is charged to a desired SOC. If the tractor battery is not charged to the desired SOC, then in step 218 regenerative energy recovery is used to charge the tractor battery. Processing then returns to step 200. If on the other hand it is determined in step 216 that the tractor battery is charged to the desired SOC, then in step 220 regenerative energy recovery is used to charge the trailer battery. Processing then returns to step 200.

If the tractor battery and the trailer battery are both fully charged during a regenerative event, then the regenerative energy may be dissipated in another way, such as through a brake resistor or by temporarily increasing the power consumption of the electrical accessories. For example, due to the high thermal inertial of the batteries, it may be possible to temporarily increase battery cooling or battery heating (and subsequently reduce the cooling/heating to compensate). This may help to ensure that regenerative braking is available and to avoid overreliance on friction brakes.

In the arrangements described above, when providing the battery 112 within the trailer 104, both the battery 112 and the environment within the trailer 104 may be affected. The battery 112 may need to be kept separate from other portions of the trailer 104, and in use the battery 112 will radiate heat which will spread within the trailer 104. The battery 112 may thus be provided in a separate, isolated battery compartment 106 within the trailer 104. There may be a thermal barrier between the battery compartment 106 and remainder of the trailer 104. The battery compartment 106 may be physically walled off.

The battery compartment 106 may be in a position within the trailer 104 that least upsets the balance of the trailer 104 and/or the truck 100 as a whole. To this end, the battery 112 may be provided in a region that is close to the bottom of the trailer 104, and/or is positioned centrally in the plane of the bottom of the trailer. The location of the battery compartment 106 may also be based on ease of access to the battery 112 for charging, maintenance work on the battery 112 itself or interoperability with other portions of the truck 100. The location of the battery compartment may also factor in the weight of the battery 112.

It may be necessary to provide the battery 112 in different locations within the trailer 104 based on, say, use of the trailer 104. A mounting arrangement may be configured to removably and/or moveably mount the battery 112 within the trailer 104. In this way the battery 112 may be able to be moved based on the load and/or route of the truck 100 and/or the trailer 104, in use, i.e. to compliment the use of the truck 100 and/or trailer 104.

The position of the battery 112 may take into consideration the center of gravity of the truck 100, so as to minimally affect the motion and/or balance of the truck 100. In an example the battery 112 may be provided in a central position towards the bottom of the trailer 104.

In another example the battery 112 may be provided in a location between wheels of the trailer. In an example, the battery 112 may be provided in a portion of the trailer 104 between an axle of a trailer chassis, or between an axle and a portion of the rim of the chassis. These arrangements further stabilize the truck 100 when carrying the battery 112. The size and weight of a battery provided within the trailer 104 can thus be efficiently distributed safely across the trailer carriage, which is itself intrinsically designed to carry heavy cargo.

The battery 112 may additionally be provided with an anti-theft mechanism so as to make unauthorized removal of the battery 112 from the trailer 104 difficult, if not impossible. The anti-theft mechanism may be integrated with a mounting arrangement such that the battery is always mounted in a secure manner. The anti-theft mechanism may include a strap, a lock or the like. The anti-theft mechanism may additionally or alternatively be configured to be in electrical communication with the tractor unit 102, such that, for example, the tractor unit 102 can be alerted to insecure mounting of the battery 112 to the trailer 104 or of an unauthorized attempt to remove the battery 112. The electrical communication may be via a physical or wired connection, for example via the connector 108, or it may be wireless.

The anti-theft mechanism may be configured to receive state of charge (SOC) information of the batteries 110, 112. In an embodiment the anti-theft mechanism is configurable for communication with the battery management system 154 and/or the system control module 150. The anti-theft mechanism may be configured to request and/or receive battery SOC information at regular intervals. The anti-theft mechanism may be configurable to receive GPS co-ordinates and/or to receive information from an electronic detection system or the like of the batteries 110, 112. In some instances, the trailer 104 and/or the batteries 110, 112 may comprise a camera. The anti-theft mechanism may be configurable to be in communication with such a camera, for example when a trailer battery 112 is disconnected and removed from the trailer 104.

In the case of a hybrid arrangement, the truck 100 may use battery power when stationary, and engine power when mobile, or a combination of the two.

The battery 112 in the trailer 104 may be arranged for use with a diesel-powered tractor unit that has a motor-generator on the mechanical drive transmission. This would allow some of the power to be diverted from the diesel-powered tractor unit to the battery 112 in the trailer 104 to charge the battery 112 and allow the battery 112 to power the tractor unit in the case where zero-emissions are required (e.g., inside a geo-fenced port) or to supplement power from the diesel engine to improve fuel economy.

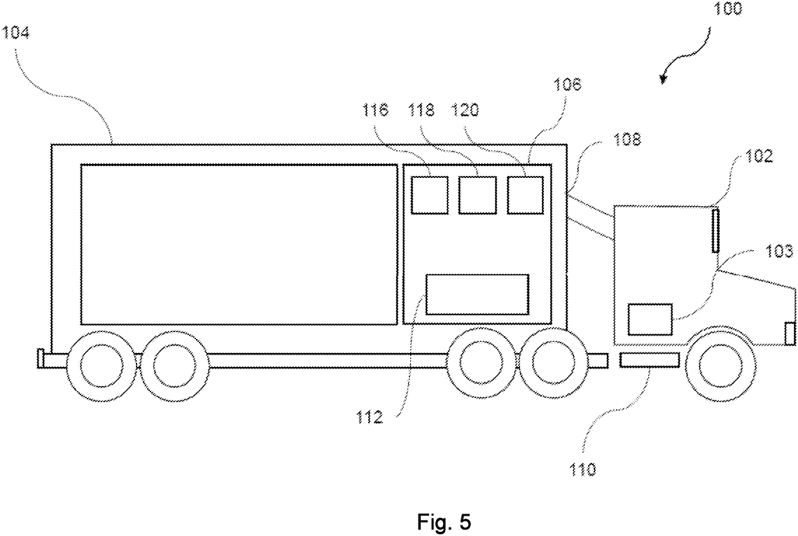

FIG. 5 shows a truck in another embodiment of the disclosure. The truck 100 comprises a sensor 116. The sensor 116 may be arranged to determine connectivity, transmit signals, or control transmission of power between the battery 112 and a portion of the truck 100, such as the trailer 104 or tractor unit 102.

The sensor 116 may be arranged to detect a secure connection of the battery 112 to the trailer 104, optionally by a mounting arrangement.

The sensor 116 may optionally communicate detection of a secure connection between the battery 112 and the truck 100, so as to permit transmission of power from the battery 112. When there is an insecure connection between the battery 112 and the truck 100, the battery 112 may be prevented from transmitting power to the truck 100, and optionally be caused to disengage from the trailer 104, electrically or mechanically.

The truck 100 comprises a communication module 118, which may be configured to facilitate communication between the battery 112 and the truck 100, for example between the battery 112 and the tractor unit 102. Such signals may be transmitted by wired and/or wireless means. The sensor 116 and the communication module 118 may be arranged to communication with one another. In an example, the sensor 116 may be configured to detect if the battery 112 is not connected to the trailer 104 in an electrically safe manner, thereby causing the communication module 118 to transmit a signal to the tractor unit 102.

In geofenced regions, reduced emission zones and the like, it is not always possible to keep an engine of a truck 100 running. Parts of the truck 100 that require power, such as powering lights when in an idle state, will either not be able to function or will require an external power source. This is cumbersome and not necessarily practical or even possible.

Maintaining certain functionalities of a truck 100 are of particular importance, say when portions of the truck 100 need to be kept refrigerated. Refrigeration of a trailer 104 requires a significant amount of energy. An alternative power source may be required to provide a functionality of the truck 100 and/or recharge the battery 112 itself. This is a particular problem if, say, the truck 100 is in transit or it is not possible to reach a charging station to charge the battery 112.

The truck 100 may be arranged to receive energy from a secondary power arrangement 120. Power received from the secondary power arrangement 120 may be arranged to recharge the trailer battery 112 and/or the tractor battery 110. A secondary power arrangement 120 may be arranged to connect to, and optionally comprise itself, a solar panel. In this way the truck 100 may be configurable to use solar power from the solar panel to provide a function of the truck 100 or to recharge the batteries 110, 112.

Alternatively or in addition, the secondary power arrangement 120 may comprise a generator set and/or a fuel cell. The secondary power arrangement 120 may be arranged to activate when, for example, the battery 112 on board the truck 100 is empty or requires recharging. The secondary power arrangement 120 may be in communication with at least one of the sensor 118 or the communication module 116. The secondary power arrangement 120 may be manually activated by an operator of the truck 100 or be arranged to automatically produce secondary power, for example when the battery 112 requires recharging.

The secondary power arrangement 120 may additionally or alternatively comprise a trailer motor. The trailer motor may be arranged to be in electrical contact with the battery 112 module. Specifically, a trailer motor may be arranged as a generator so as to derive power as the trailer 104 is dragged by the tractor unit 102.

The trailer motor may additionally or alternatively be arranged to transform and/or store energy when the wheels of the trailer 104 are decelerating and brought to a stop (regenerative braking). This may be when the truck 100 is caused to brake.

The truck 100 may be arranged to harvest regenerative energy in other ways, so as to charge on board batteries and thereby increasing the amount of time the truck 100 is able to travel without stopping to recharge the battery. In another example, the trailer 104 is configured to harvest energy when travelling down a slope or incline.

By having additional batteries on board the truck, particularly a battery 112 provided in the trailer 104, such regenerative energy is able to be harvested even when conventional batteries, such as the tractor unit battery 110, are fully charged or not configured to receive harvested regenerative energy, particularly during a journey.

The battery 112 may be arranged to provide power to other portions of the truck 100, such as, for example, lights of the tractor unit 102.

The trailer 104 may comprise an air slot to facilitate cooling of the battery 112. In one example, the air slot is provided in the battery compartment 106, in close proximity to the battery 112. Air slots may be located at the bottom of the trailer. The air slots may direct heat from the battery 112, optionally from the battery compartment 106, to, say, a refrigeration unit of the trailer 104 or the truck 100. Additionally or alternatively, the air slots may direct heat from the battery 112, optionally from the battery compartment 106, to an aeration component of the trailer 104 configured to actively or passively cool the hot air from the vicinity of the battery 112. Said active or passive cooling of the hot air by an aeration component of the trailer 104 may be triggered based on a thermostat reading or the like of battery 112 and/or the hot air extracted from the vicinity of the battery 112. The trailer 104 may comprise heat pipes arranged in the wall(s) of the trailer 104, the heat pipes being arranged to carry hot air away from the battery 112, optionally from the air slots, such that the hot air from the battery does not interfere with the remainder of the environment within the trailer 104.

It is important for the trailer 104 to be well equipped to handle extreme and even dangerous temperatures the battery 112 may reach during operation. Thermal runaway events can cause great damage to batteries 110, trailers 104 and trucks 100. Should a tractor unit battery overheat and undergo a thermal runaway event in the vicinity of an engine or motor, particularly one which uses hydrogen, serious damage could be caused not only to the truck 100, but also to objects and people in the vicinity of the truck 100.

The trailer 104 may be equipped to identify thermal properties of each battery 112 provided within the trailer 104. Thermal events or dangerous conditions of individual batteries 112 can thus be predicted and rectified. In an example, the trailer 104 may be configured to shut down or otherwise electrically isolate an overheating battery. In some instances, it may be necessary to eject a possibly explosive battery and to distance the truck 100 from the battery. The trailer 104 may include battery isolation logic for electrically and/or physically separating a battery from the remainder of the trailer. In some embodiments, a battery management system or battery control system is arranged to monitor the thermal properties of each battery, and optionally to invoke battery isolation logic.

The battery 112 may be configured to be expelled from within the trailer 104, optionally under the control of a battery management system or the like. For example, the battery 112 may be dropped from the bottom of the trailer 104. Such expulsion of the battery 112 from the trailer 104 is far easier than removing or ejecting a battery 112 from a tractor unit 102. Batteries provided in or near the tractor unit 102 are also likely to be in close proximity with engines and motors. Therefore, in one example, the battery 112 is located a distance away from the tractor unit 102.

The trailer 104 may include quick trailer-release means for disconnecting and releasing the trailer 104 from the tractor 102. It may not be possible to safely isolate and drop an overheating battery. Trailers are more cheaply manufactured and maintained than tractors, and it may be desirable to drop an entire trailer if there is risk of damage, fire or explosion from remaining attached to the trailer 104.

The battery 112 may be configured to be automatically ejected from the trailer 104, for example under a decision of the battery management system. In another example the battery 112 may be ejected under a command from the tractor unit 102, say, by a driver of the truck 100 upon pressing a button at the tractor unit 102.

The truck 100 may comprise a cooling system for cooling the truck 100. For example, the cooling system may be arranged to cool an engine of the tractor unit 102, the trailer 104, and/or the battery 112.

The truck 100 may comprise a coolant hose arranged to carry coolant to and/or from a part of the truck 100. The coolant hose may be part of the cooling system.

The truck 100 may comprise battery isolation logic arranged to identify failures of the battery 112. The battery isolation logic may be arranged to be in communication with other portions of the truck 100, such as the tractor unit 102, the sensor 116 and/or the communication module 118. The battery isolation logic may enable electrical connection/disconnection of the battery 112 from the truck 100. This is a useful safety feature when, say, a battery 112 is removed from the trailer 104, or replaced with another battery 112.

Truck 100 may comprise a tractor unit control module in contact with any other portion of the truck 100, thereby enable monitoring and controlling of various components of the truck 100 from the tractor unit 102.

The truck 100 comprises a connector 108 for connecting the trailer 104 and the tractor unit 102. In an example when the battery 112 is empty and it is not possible to reach a recharging station, the engine of the tractor unit 102 may be arranged to charge the battery, such that the battery is able to continue providing power to the truck.

Power from the battery 112 may also be directed to other portions of the trailer 104, such as for operation of e-lifts, locking mechanism and gates, operation of coolant systems or powering e-axles.

The connector 108 may thus facilitate the sharing of power in a safe and secure way. In this way the connector 108 enables flexible usage and management of power from the battery 112. Optionally the connector may comprise a coolant channel for passing coolant between the tractor unit 102 and the trailer 104.

Optionally the truck 100 may comprises an additional undercarriage battery also arranged to provide either the battery 112, tractor unit battery 110 or the traction motor 103 with energy.

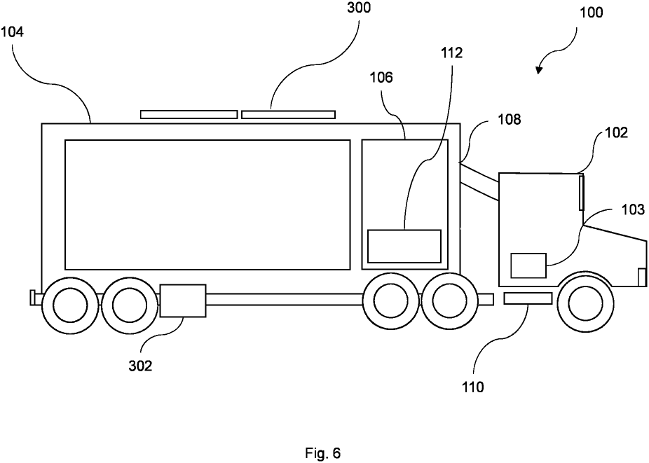

FIG. 6 shows schematically a truck 100 according to another embodiment of the disclosure.

When, for example, the battery 112 is in heavy use, a secondary power source may be required.

In this embodiment, the truck 104 comprises a solar panel 300. The trailer 100 may be arranged to retrieve solar energy via the solar panel 300, for charging of the trailer battery 112, the tractor battery 110 and/or supplying power to other components. The solar panel 300 is optionally provided on the roof of the trailer 104. The system control module 150 within the tractor unit 102 determines how to bias the energy harvested, and how the energy is distributed within the system. The flow of energy to the batteries 110, 112 is determined by the desired SOC of each battery.

A complex solar power system may be required to allow solar energy to be captured, transformed and used by the truck 100. Such a solar power system, with the exception of the solar panel itself, may be housed within the trailer 104, at least owing to the space available within the trailer 104.

Solar power is just one example of using a renewable energy source to power or charge portions of the truck 100.

In this example the trailer 104 is an e-trailer 104 comprising an e-axle 302. The e-axle 302 comprises one or more traction motors arranged to drive one or more wheels. The battery 112 may supply power to the e-axle 302. In one example power may be circulated between the e-axle traction motor and the battery 112.

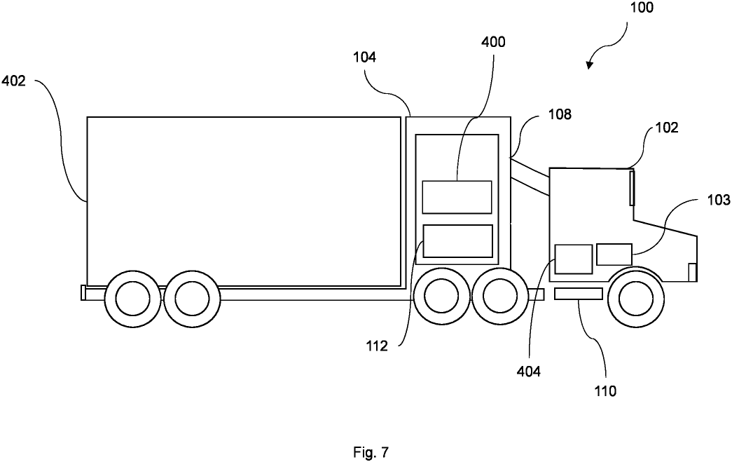

FIG. 7 shows another example embodiment of the present disclosure. The tractor unit 102 of the truck 100 comprises a traction motor 103 and tractor battery 110, and optionally a fuel cell or engine 404. The trailer 104 is used to carry a shipping container 402. The trailer 104 comprises trailer battery 112 and an engine or fuel cell 400. By having a dedicated fuel cell 400, the battery 112 can be charged using the fuel cell 400.

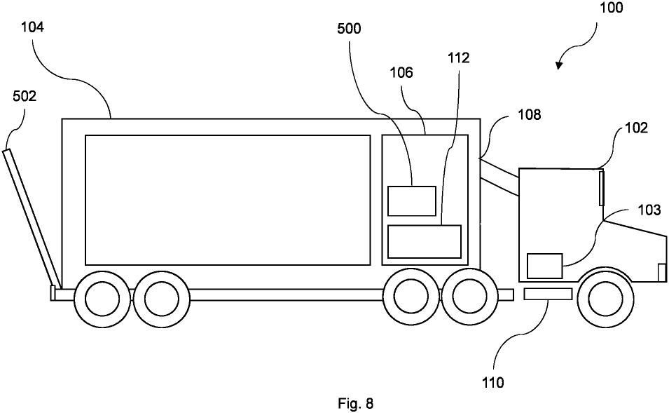

FIG. 8 shows another example embodiment of the present disclosure. The truck 100 comprises a battery 112, a tractor unit 102 comprising a traction motor 103 and a tractor unit battery 110, a hotel module 500 and an electric gate 502. The hotel module 500 may be arranged to provide power to the truck 100 when, for example, the truck 100 is stationary and the engine of the truck 100 is not operational. This may be of particular use in green or no emission zone where it is not possible to keep an engine of an immobile truck 100 running in order to, say, power lights of the truck 100 or operate a reefer system.

The hotel module 500 may facilitate the sharing of power from the battery 112 to, say, a cooling system of the truck 100, headlights, tail lights and the electric gate 502, for operation of e-lifts, or portions of the chassis, such as e-axles. Energy from the battery 112 may also be shared with an entirely different entity, such as another trailer or truck.

In an example, the truck 100 may comprise a cooling system electrically connected to the hotel module 500. In this way the cooling system is able to function independently of the engine of the tractor unit 102.

The cooling system may be arranged to regulate the temperature of all or part of the truck 100. Additionally or alternatively, the cooling system may be arranged to regulate the temperature of a refrigerated trailer. As the battery 112 is provided within the trailer 104, the size and capacity of the battery 112 will be able to perform high-energy functions such as keeping a refrigerated trailer cool.

The cooling system may comprise a tractor unit cooling system.

The cooling system may be a battery cooling system for cooling the battery 112, and/or a trailer 104 cooling system for keeping the trailer 104 refrigerated. Such a trailer cooling system may be configurable to cool the battery 112. Additionally or alternatively, the cooling system may be truck cooling system for cooling, say, the tractor unit 102, specifically a tractor unit engine.

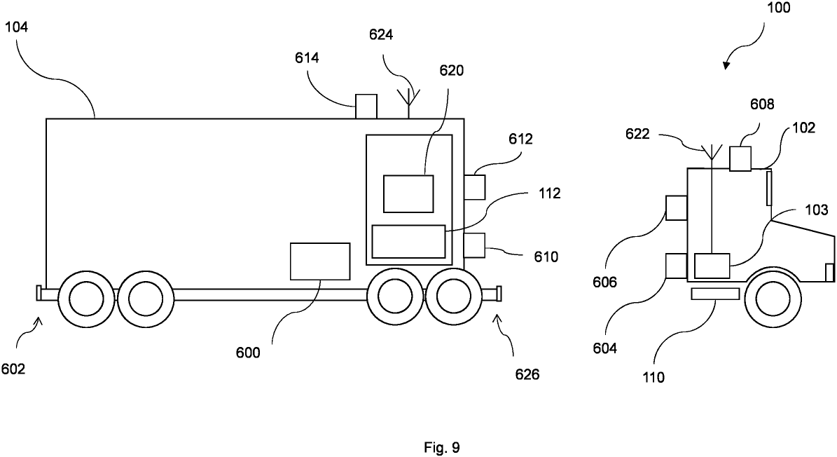

FIG. 9 shows schematically a truck 100 according to an embodiment of the disclosure.

The trailer 104 comprises a trailer motor 600 arranged, in conjunction with the battery 112, to enable the trailer 104 to operate autonomously, even when the trailer is not connected to a tractor unit 102. Such an autonomous trailer 104 may be configured to navigate towards and connect with a tractor unit 102. The trailer motor 600 and the battery 112 may specifically be configured to enable an electric powertrain of the trailer 104 to function, so as to enable the trailer 104 to move autonomously. The trailer 104 comprises a trailer control module 620 arranged to control the trailer 104 when it is not connected to the tractor unit 102. The battery 112 is used to supply power to motor 600 under control of the control module 620 when the trailer is operating autonomously. The trailer control module may receive and input from an operator or other components on the trailer or elsewhere for use in controlling the motor 600. The control module 620 may additionally or alternatively be configured to communicate with the tractor unit 102 so as to co-ordinate movement and subsequent connection of the trailer 104 with the tractor unit 102.

Alternatively or in addition, the trailer 104 could be an e-trailer comprising at least one e-axle. The e-axle may comprise one or more traction motors arranged to drive one or more wheels. In this case the battery 112 may supply power to the e-axle.

In this example the trailer 104 comprises a maneuvering portion 602. The maneuvering portion 602 may be fixed to the trailer, such that once the trailer 104 is engaged with the tractor unit 102, the maneuvering portion 602 moves as part of the truck. Alternatively, the maneuvering portion 602 may be temporarily secured to the trailer 104, such that the maneuvering portion 602 is configured to move under the power of the trailer motor 600 and the battery 112, but is configured to wholly or partly separate or retract from the trailer 104. In this way, the maneuvering portion 602 is able to move the trailer 104 towards the tractor unit 102 and load the trailer onto a chassis or the like of the truck 100, and then move away from the truck 100.

The maneuvering portion 602 may be automated when the trailer motor 600 and the battery 112 provide power to the landing portion. The maneuvering portion 602 may be configured to steer the trailer 104 when operating under the power of the trailer motor 600 and the battery 112.

The maneuvering portion 602 comprises retractable portions. In an example at least part of the maneuvering portion 602 may be arranged to disconnect from the trailer 104 as the retractable portion retracts from the trailer 104. The maneuvering portion 602 may be automated so as to both steer the trailer 104 and retract necessary portions simultaneously. In this way the trailer is configurable to operate autonomously and in a safe and reliable manner.

Optionally the trailer 104 comprises a landing portion 626, configured to engage with the tractor unit 102 when the trailer 104 and the tractor unit 102 are brought together. The landing portion 626 may itself have a retractable portion, configurable to open out for engagement with the tractor unit 102 and/or to retract when the trailer 104 is disengaged from the tractor unit 102. Additionally or alternatively, the tractor unit 102 may comprise the landing portion, configured to engage with the trailer 104.

In this example the tractor unit 102 comprises at least one of a tractor radar 604, a tractor camera 606 and a tractor lidar 608, each for assisting alignment, and subsequent connection, of the trailer 104 with the tractor unit 102. The tractor unit 102 may comprise all, none or a selection of the tractor radar 604, a tractor camera 606 and a tractor lidar 608, and other such sensors, camera and receptors arranged for assisting the connection of a trailer 104 to the tractor unit 102.

The trailer 104 may comprise all, none or a selection of complimentary sensors, cameras and/or receptors to assist alignment and connection of the trailer 104 to the tractor unit 102. In this example the trailer 104 comprises a trailer radar 610, trailer camera 612 and a trailer lidar 614. The battery 112 may be arranged to provide power to all, none, or a selection of the trailer radar 610, trailer camera 612, the trailer lidar 614, and other sensors, cameras and receptors or the like of the trailer 104. Thus, the trailer 104 is able to function on its own without relying on an external power source, such as a tractor unit battery 110 prior to connection with the tractor 102.

The tractor unit 102 may comprise a tractor unit control system (not shown) for facilitating connection between the tractor unit 102 and the trailer 104. The tractor unit 102 may comprise an antenna 622 and the trailer 104 may comprise an antenna 624, and the antennas may enable communication between the tractor unit and the trailer

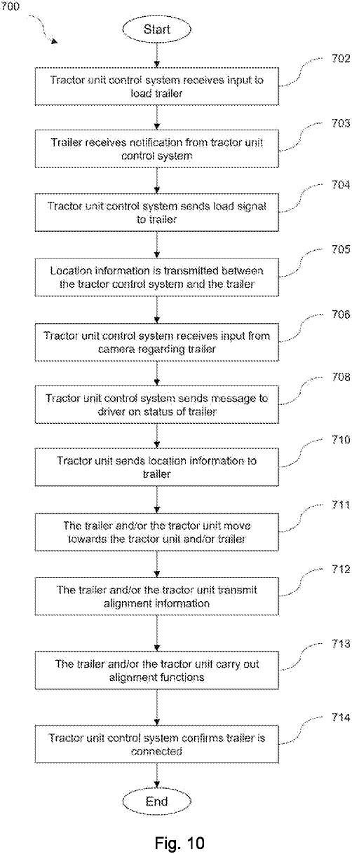

FIG. 10 shows steps carried out by a control system for alignment of the tractor unit 102 with the trailer 104 in the embodiment of FIG. 9.

The operation 700 facilitates the connection of a trailer with a tractor unit. In a first step 702 a tractor unit control system receives an input to load a trailer. This input may be transmitted to the tractor unit from, say, an operator, telematics system and/or the trailer itself.

Additionally or alternatively, the trailer may receive an input from the tractor unit control system at step 703, notifying the trailer that a tractor unit will soon connect to and move the trailer, optionally from an operator or telematics system.

At the next step 704 the tractor unit control system transmits a load signal to the trailer. Optionally the signal is sent to the trailer via a vehicle to trailer communication system.

The trailer may thus begin preparation for movement, for example by activating accessories such as lights and/or sensors and the like, or even by moving itself to a pick up location. Additionally or alternatively, the trailer may transmit a signal to the tractor unit confirming preparation

At step 705, the tractor unit control system transmits location information of the tractor unit to the trailer, such that the trailer is notified of the exact location of the tractor unit. Additionally or alternatively, the trailer may be configured to transmit its own location signal to the tractor unit control system so as to notify the tractor unit of the exact location of the trailer. The location of at least one of the trailer and the tractor unit may be determined by all, or a selection of GPS transmitter/receivers, antennas and aerials located at the trailer and/or the tractor unit. Such transmitters/receivers, antennas and aerials may be integrally provided with the trailer and/or tractor unit, or they may be provided as part of an external device, for example using a smart phone configured for use with, and located at, the trailer and/or tractor unit.

At the next step 706 the tractor unit control system receives an input from a tractor unit camera relating to the trailer. Said input may, for example, notify the tractor unit control system of a metric such as distance and direction of the trailer from the tractor unit. Additionally or alternatively, the input may be received from all, a selection or none of a tractor unit radar and/or lidar, a trailer camera, trailer radar, trailer lidar, or the like. The tractor unit control system may prompt the trailer to transmit said metric for receipt at the tractor unit.

At the next step 708 the tractor unit control system transmits a status message to a driver of the tractor unit on the status of the trailer. The status message may be based on camera/radar/lidar information of either or both of the tractor unit and the trailer. The status message may be transmitted to a component on the tractor unit, such as at a screen or control unit within the tractor unit, or to a separate device entirely.

At the next step 710 the tractor unit sends location information to the trailer, optionally based on camera/radar/lidar information which itself is optionally transmitted via the vehicle to trailer communication system.

At step 711, at least one of the trailer and the tractor unit move towards, for engaging with, one another.

At a step 712, at least one of the trailer or the tractor unit may transmit alignment information to the tractor or trailer unit, respectively, to assist connection of the trailer and the tractor unit. At a step 713 the trailer and/or the tractor unit may carry out alignment functions, for example by causing the trailer and/or the tractor unit to move in small increments relative to one another, based on the alignment information. Said alignment functions may be implemented automatically or by, say, an operator of the trailer and/or tractor unit, so as to align the trailer and the tractor in preparation for connection to one another.

Said alignment may occur before the at least one of the trailer and the tractor unit begin to move towards one another. In this way the trailer and the tractor unit are optimally configured for engagement with one another prior to any movement. Additionally or alternatively, the alignment may occur after the trailer and/or the tractor unit have begun to move towards the tractor unit and/or trailer, respectively. Positioning and/or movement of the trailer and/or the tractor unit may be corrected as they near one another, thereby ensuring secure and complete engagement of the trailer and the tractor unit.

At the next step 714 the tractor unit control system confirms that the trailer is connected to the tractor unit. Said confirmation may be via an audio and/or visual output, such as a light on the tractor unit or a sound at a device accessible by the driver.

In an example, on the basis of the confirmation at step 712 a driver or operator, or the like may receive an input to connect a connector between the tractor unit and the trailer. The input may be received at the tractor unit, the trailer and/or at a different device entirely, such as a handheld operator unit. Alternatively, engagement of the trailer with the tractor unit may comprise automatic engagement of complimentary parts of a connector located on the tractor and the tractor unit, such that manual connection is not required. The connector itself may be in communication with the tractor unit control system. Additionally, the tractor unit control system may be configured to transmit a message to the driver/operator. Further, at least one of the tractor unit and the trailer may be configured to transmit a message to the trailer and the tractor unit, respectively, to indicate secure connection of a connector between the trailer and the tractor unit.

The tractor unit control system may be configured to be in electrical and/or wireless communication with all, none or a selection of components of the trailer.

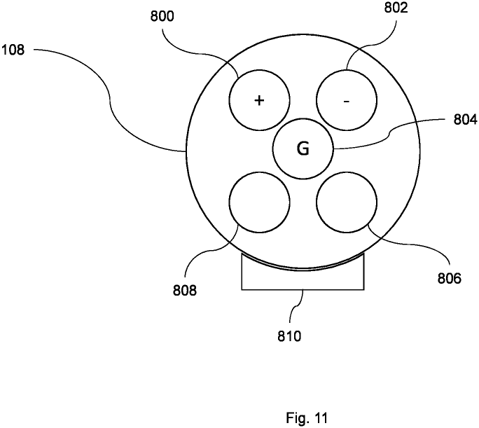

FIG. 11 shows schematically an example of a connector 108 in an embodiment of the disclosure.

A connector 108 must be electrically safe for use, particularly when the connector 108 connects a battery to a tractor unit of the truck. In this example the connector 108 comprises at least one conductor channel configurable to electrically connect the battery to the tractor unit. The connector 108 may be a flexible connector. The connector 108 may comprise a positive conductor 800 and a negative conductor 802. Additionally, the connector 108 may comprise a ground conductor 804. The connector may also comprise one or more network cables.

The connector 108 may be integrated with a coolant hose. The coolant hose may be configured to circulate coolant between the battery and the tractor unit of the truck. In this example the connector comprises plural coolant channels 806, 808.

The battery may be arranged to exchange signals with the tractor unit, confirming connection of the battery to the truck. Such a signal may be transmitted through a conductor of the connector 108. Additionally or alternatively, the signal may be transmitted to/from the battery via another component, such as a communication module as described above. A lock mechanism 810 of the connector 800 may be activated to secure the connection connector 108, so as to prevent unsafe or unexpected disconnection of the connector from the trailer or the tractor unit. The lock mechanism 810 may be electrically and/or manually configurable.

Once a connection is established between the trailer and the tractor unit, signals and power may pass between them via the connector. Such signals may include information relating to the battery pack such as the state of charge, battery age, state of health, temperature, and information regarding cooling systems of the trailer.

The connector 108 may be arranged such that if a disconnection occurs (for example due to a collision) the connector 108 opens and no power is able to travel between the battery and the remainder of the truck.

The connector 108, or at least one of the conductors 800, 802, 804 the coolant channels 806, 808 and the lock mechanism 810 may be configurable to communicate with, say, a sensor, communication module and/or tractor unit of the truck.

In an example, the tractor unit may transmit a signal to disconnect the tractor unit from the trailer, optionally by opening the conductor(s) 800, 802, 804. Such a signal may also be arranged to isolate any potential coolant flowing within the first and/or second coolant hoses 806, 808.

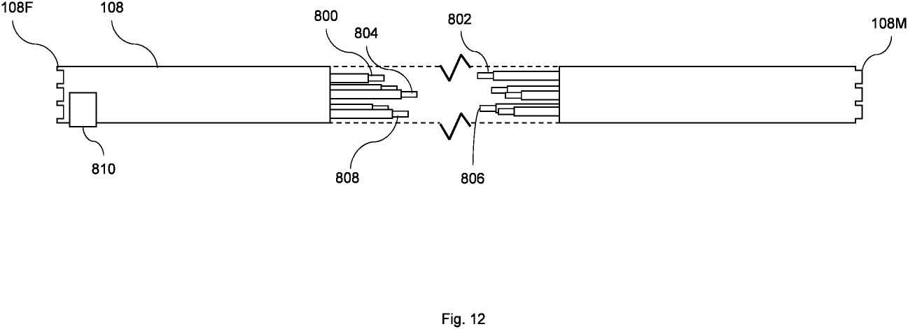

FIG. 12 shows schematically a side view of the connector 108 of FIG. 11. The connector 108 comprises a female portion 108F and a complimentary male portion 108M. One of the female portion 108F or the male portion 108M is configurable to fit onto a complimentary male or female portion on the truck. In an example, the connector female portion 108F is configured to connect to a trailer, optionally to a battery compartment within the trailer, and the connector male portion 108M is configured to connect to a tractor unit. The cable also comprises a lock mechanism 810 for securing the end of the cable to the complimentary portion on the truck. There may be a lock mechanism 810 on each end of the connector 108.

The battery as described above may be provided in a self-contained battery tandem trailer, arranged to be dragged by a tractor unit of a truck. Said tandem trailer may be configurable to be attached to a part of the truck, for example between a tractor unit and a trailer already present as part of the truck, or at the rear of the truck.

Plural such tandem trailers can be used as required to meet distance and cargo requirements, for example during line-haul and long distance journeys.

Trailers and trucks as described above may be provided with a control module arranged to oversee and control integration of the battery within the trailer and/or truck. The control module may be arranged, optionally in combination with any other portion of the truck, to control the transmittal of power from the battery and/or charging of the battery.

It will be appreciated from the above that, in a conventional battery electric vehicle, there will be practical limitations due to the amount of battery that can be packaged on the tractor unit. This will inherently limit how far one can go on a given charge before having to recharge. By adding batteries to the trailer, the time between recharging events can be prolonged, and when recharging is required, the tractor unit can either pick up a freshly charged trailer and be immediately operational, or quickly swap in a pre-charged trailer-mounted battery system. This avoids the downtime associated with waiting for the tractor-mounted battery system to charge. Furthermore, it allows charging to occur at a slower rate since the battery is decoupled from the tractor, lessening the need for a high performance and costly charging system, and prolonging the life of the battery through a slower charge.

In any of the above embodiments, the trailer could feature a plurality of battery packs (in connection with each other). The trailer could feature of plurality of connector types to allow for connection to different model tractors. The trailer batteries could be integrated with (e.g. used as a backup power supply for) the trailer’s refrigeration unit.

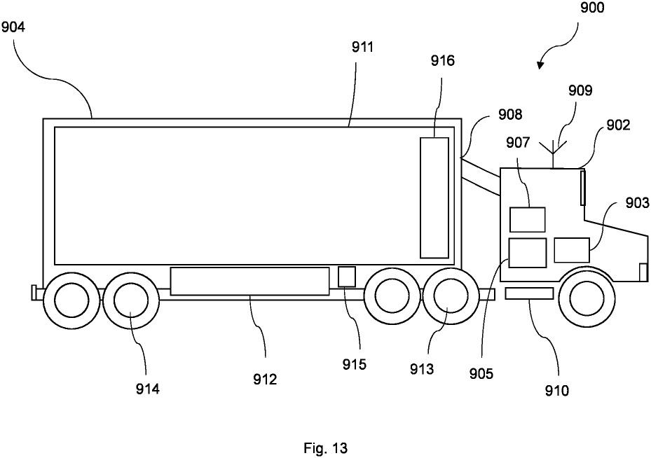

FIG. 13 shows a truck in another embodiment of the disclosure. The truck 900 comprises a tractor unit 902 and a trailer 904 which may be in any of the forms described above. The tractor unit 902 comprises a traction motor 903 which provides mechanical power to the drivetrain of the tractor unit, and a battery 910 which provides electrical power for the traction motor. In this example the tractor unit 902 also includes a secondary power source 905, which may be for example an engine or a fuel cell, although this is optional. A control system (electronic control module) 907 is provided for controlling the tractor unit powertrain, including the traction motor 903 and/or secondary power source 905. An antenna 909 is provided for connectivity. The trailer 904 comprises a storage compartment or region 911, and a trailer chassis. A trailer battery 912 is mounted on the trailer chassis. The battery 912 is electrically connected to the tractor unit 902 by means of a connector 908. In this example the trailer includes one or more front e-axles 913 and one or more rear e-axles 914. The e-axles each comprise one or more motors arranged to drive wheels. The trailer battery 912 is arranged to provide power to the e-axles 913, 914. The e-axles may also operate in a regenerative mode and supply power to the trainer battery, for example during braking or when traveling downhill. In the arrangement shown, the trailer 904 includes an optional electronic control module 915 for controlling power to and from the trailer battery 912. In this example the trailer 904 is a refrigerated trailer, or reefer, and includes an electrified trailer refrigeration unit (TRU) 916.

The truck of FIG. 13 therefore comprises an electrified powertrain and an electrified trailer. The electrified trailer is capable of regenerative braking and/or over the road recharging. The trailer uses the energy in the trailer battery to power the refrigeration unit (refrigerated trailer).

In embodiments of the present disclosure, a system for optimizing and managing an electrified trailer for heavy-duty vehicles is provided in which the regenerative braking split between the tractor battery and the trailer battery is actively managed for optimal energy and fuel utilization.

In one embodiment, a controller (for example, control system 907) determines the regenerative braking needed to maintain sufficient trailer battery capacity for the refrigeration unit. In this embodiment, the controller keeps account of the refrigeration energy/power consumption and estimates the range based on the battery state or remaining capacity. The controller receives information from connectivity devices on the range requirement for the current trip and uses that information to manage the trailer battery in such a way as to reach a desired level of depletion at the destination. For example, if the battery will be recharged with off-board power at the destination (e.g. electric grid) then the regenerative braking split may be managed in such a way that the trailer battery will be substantially depleted (low SOC) at the destination. The controller determines a battery depletion target along the route, which may be dynamic or static. The controller determines the regenerative braking needed to maintain the battery at the desired depletion level (based on, for example, range, power consumption, depletion target, distance to destination, and/or any other appropriate parameter).

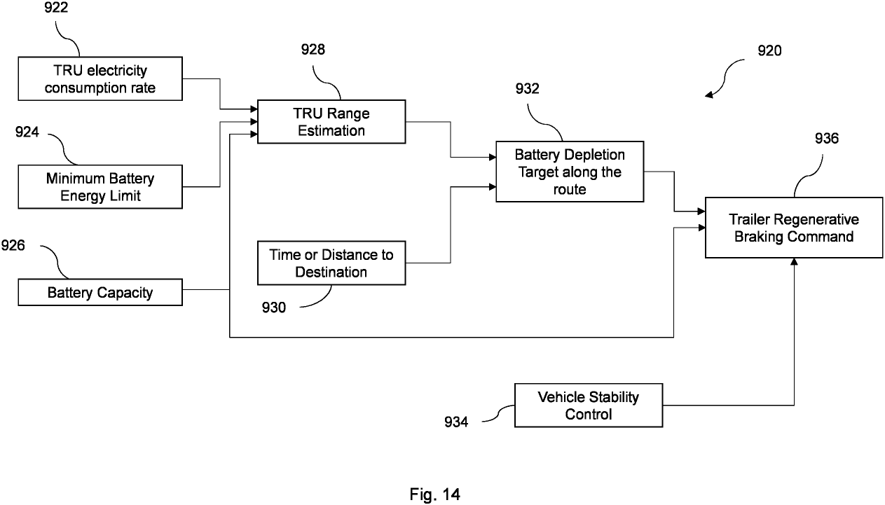

FIG. 14 is a flowchart showing a process 920 carried out by the controller in this embodiment. The controller optimizes regenerative braking based on the state of charge of a battery provided on a refrigerated truck, or reefer, travelling to a predetermined destination. The controller may be configurable for monitoring power consumption of the refrigeration unit and estimating a range of the battery based on the state of the battery. Referring to FIG. 14, in step 922 the controller monitors or measures the electricity consumption rate of the refrigeration system. This may be achieved using a signal from the refrigeration unit which is received by the controller. In step 924 the controller obtains the minimum energy limit of the trailer battery. This may be a predetermined value, or may be set by the truck operator or transmitted over the air. In step 926 the controller determines the remaining capacity or energy level of the battery. This may be achieved using a signal from the battery, which may be provided for example by a battery management system. In general, monitoring may include receiving information at the controller and/or the controller actively requesting information from the truck, refrigeration system, or other device such as a sensor or over the air via the antenna. In step 928 the controller uses the electricity consumption rate, battery energy limit and battery capacity in calculation of a refrigeration system range estimation. The range estimation may be the estimated distance or time remaining before the battery reaches the minimum battery energy limit. In step 930 the controller also receives journey information such as the time or distance remaining until the truck reaches a destination. This may be for example set by the operator or received over the air, and may be updated depending for example on traffic conditions. Such journey information is also useful when drain and charge of batteries are scheduled to compliment inclines and declines anticipated on journey of the truck. Using the range estimation and the time/distance to destination, in step 932 the controller determines a battery depletion target along the route being undertaken by the truck. The battery depletion target may be dynamic or static.

In step 934 the controller receives vehicle stability control information. This information may be received, for example, from an electronic control module responsible for controlling the truck’s powertrain and stability. In step 936, using the battery depletion target, the battery capacity and the vehicle stability control information, the controller determines an optimal trailer regenerative braking command. In this way the controller determines the amount of regenerative braking to direct to the trailer battery to achieve a desired level of depletion of the battery at the destination, based on the range of power consumption of the truck, depletion target, distance to a destination etc.

For example, if it is known that the battery can be recharged at the destination, then the controller may control the split of regenerative braking between the truck and trailer batteries such that the trailer battery is substantially depleted (close to its minimum energy limit) at the destination. This may help to maximize the charge in the truck battery, allowing continued use of the truck without the need for recharging. On the other hand, if the destination is for example a truck stop without a grid supply, then the controller may control the regenerative braking split such that the energy in the trailer battery is maximized. This can allow the trailer battery to continue to power the refrigeration unit at the destination without requiring use of an internal combustion engine or a grid connection. It will be appreciated other values of the depletion target may also be used, depending on the expected use of the trailer battery at the destination and the presence or absence of a grid supply or other form of power.

In another embodiment, the controller determines the optimal regenerative braking split between tractor and trailer in order to achieve optimal vehicle/powertrain level operation. This can help to optimize efficiency across different trailer weights and loads, thereby reducing fuel consumption and/or improving range.

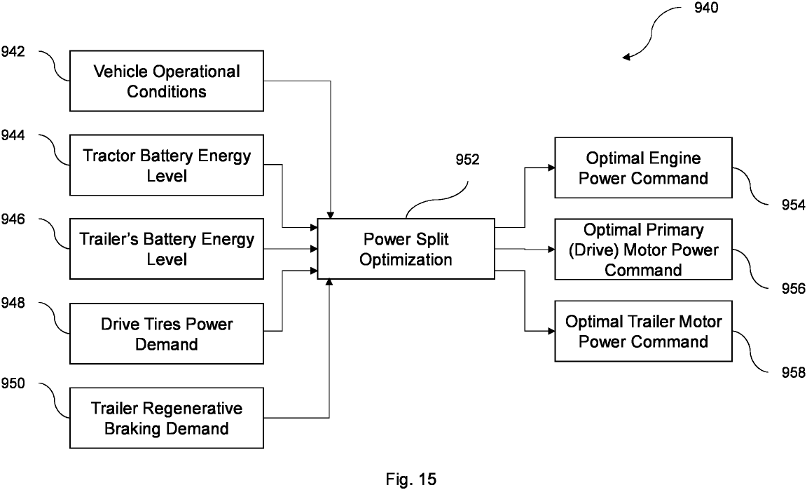

FIG. 15 is a flowchart showing a process 940 carried out by the controller in this embodiment. Referring to FIG. 15, in step 942 the controller receives information relating to at least one vehicle operational condition, such as an acceleration command, a braking command etc. In step 944 the controller receives the tractor battery energy level, for example, from a battery management system in the tractor battery. In step 946 the controller receives the trailer battery energy level, for example, from a battery management system in the trailer battery. In step 948 the controller receives a drive tires power demand signal indicating a demanded power for the drive tires. In step 950 the controller receives a trailer regenerative braking demand indicating a demanded regenerative braking level of the trailer. In step 952 the controller determines the optimal regenerative braking split between tractor and trailer based on the vehicle operational conditions, tractor battery energy level, trailer battery energy level, drive tires power demand and trailer regenerative braking demand, in order to optimize efficiency and/or performance. In step 954 the controller outputs an optimal engine power command for controlling an engine (where present). In step 956 the controller outputs an optimal primary motor power command for controlling the tractor motor. In step 958 the controller outputs an optimal trailer motor power command for controlling the trailer motors (for example, in one or more e-axles). The power commands may be to propel or to retard (retard being regenerative braking).

In another embodiment, the controller uses vehicle dynamic stability information/considerations for safely determining the split ratio limits. Overdriving the rear of a truck, particularly under the decision of a process or algorithm to, say, execute regenerative braking of the truck may in some instances be unfavorable or even dangerous. For example, in adverse weather conditions, overdriving the rear of a truck may cause skidding of tires and wheel slip. In this embodiment the controller factors in such information relating to the stability of vehicle when determining the optimal power split.

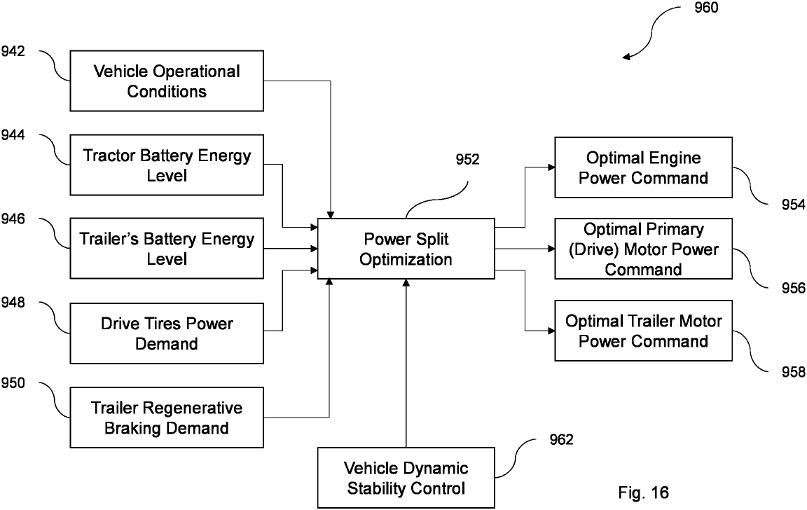

FIG. 16 shows schematically a flowchart of a process 960 in this embodiment. The process 960 of FIG. 15 corresponds to that of FIG. 15 with additional consideration for dynamic stability of the vehicle. Referring to FIG. 16, in step 962 the controller receives a vehicle dynamic stability control signal from the vehicle’s electronic stability control (ESC) unit. The electronic stability control unit is typically arranged to detect loss of steering control and to automatically adjust the brakes and/or traction motor to help steer the vehicle in the intended direction. In step 952 the controller determines the optimal regenerative braking split based on the vehicle dynamic stability control signal as well as the vehicle operational conditions, tractor battery energy level, trailer battery energy level, drive tires power demand and trailer regenerative braking demand, in order to ensure stable operation of the vehicle. Other parts of the process 960 are essentially the same as those described above with reference to FIG. 15, and therefore are not described further.

In another embodiment, over the road recharging operation is performed when there is no active braking and the trailer battery level is becoming too low. In this embodiment, when the vehicle is not braking sufficiently to maintain the desired battery depletion level, the controller will demand over the road recharging. This is when the powertrain is in tractive propulsion mode (positive torque) and the controller demands a negative torque on the trailer motors to charge the trailer battery. This will effectively put a load on the powertrain (a dragging force) and it is a means for maintaining the trailer battery state when there is no active braking. Such over the road recharging can be implemented in the power split optimization step 952 of FIGS. 15 and 16.

Over the road charging can also be used in situations other than when the trailer battery level is too low. For example, the method can be activated when the trailer battery level is below the target (desired) trailer battery level.

In another embodiment, the controller communicates with a fleet management center for updates and learning. In this embodiment, the controller communicates current and past states to the fleet management center. The fleet management center uses the information from the trailer systems to learn and for performance optimization. The fleet management center sends updates to the trailer system for performance tuning. The fleet management center sends updates to the trailer system regarding commands, such as, but not limited to, distance to destination and desired depletion level at destination, and refrigeration unit settings (temperature setting, humidity setting, etc.)

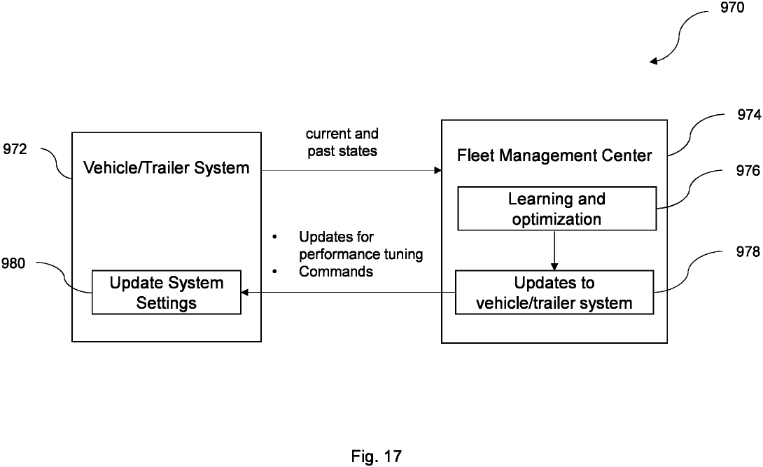

FIG. 17 shows schematically a fleet management system 970 in this embodiment of the disclosure. Referring to FIG. 17, the fleet management system 970 comprises vehicle/trailer system 972 and fleet management centre 974. The vehicle/trailer system 972 is arranged to send current and past states to the fleet management centre 974 via connectivity devices. The fleet management centre 976 may also receive current and past states from other vehicle/trailer systems in the fleet. The fleet management centre 976 comprises a learning and optimization module 976 and a fleet update module 978. The learning and optimization module 976 uses the current and past states from the vehicle/trailer system 972, as well as those from other vehicle/trailer systems, for machine learning and performance optimization. An output of the learning and optimization module 976 is fed to the fleet update module 978.

The fleet update module 978 uses the output of the learning and optimization module 976 to determine updates to the vehicle/trailer system for performance tuning. The system updates are sent to a vehicle update module 980 in the vehicle/trailer system 972. The vehicle update module 980 uses the updates to update the vehicle/trailer system for performance tuning. For example, the vehicle update module 980 may update any of the processes described above with reference to FIGS. 14 to 16. The fleet update module 978 also determines commands such as distance to destination and desired trailer battery depletion level at destination (or another location), and refrigeration unit settings, such as temperature setting, humidity setting, etc. The commands and settings are set from the fleet update module 978 to the vehicle update module 980. The vehicle update module 980 uses the commands/settings to update the parameters used in the processes of FIGS. 14 to 16 as well as the parameters of the trailer refrigeration unit.

Embodiments of the disclosure have been described above by way of example only. Features of one embodiment may be used with any other embodiment. Other modifications will be apparent to the skilled person within the scope of the claims.

We claim:

1. A trailer arranged to be coupled to a tractor unit, the tractor unit comprising an electric or hybrid electric powertrain and a control system for controlling the powertrain, wherein the trailer comprises a trailer battery and the trailer battery is arranged to provide power to the powertrain under control of the control system, the control system comprising a control module arranged to provide signals for controlling the trailer battery and the trailer battery comprising a battery management system arranged to receive the control signals and to control the trailer battery in dependence thereon.

2. The trailer of claim 1, wherein the battery management system is arranged to determine a state of charge of the trailer battery and to transmit a signal indicating a state of charge of the trailer battery to the control module, and the control module is arranged to manage flow of power between the trailer battery and the powertrain based on the signal indicating a state of charge of the trailer battery.

3. The trailer of claim 1, wherein the powertrain is configured to provide regenerative power to the trailer battery under control of the control module.

4. The trailer of claim 1, wherein the trailer comprises a battery compartment and the trailer battery is housed within the battery compartment.

5. The trailer of claim 4, wherein the trailer comprises a cargo compartment separate from the battery compartment.

6. The trailer of claim 1, further comprising a mounting arrangement for removably mounting the trailer battery within the trailer.

7. The trailer of claim 1, further comprising a secondary power arrangement for providing electrical power to the trailer battery, wherein the control system is arranged to manage flow of power between the trailer battery, the powertrain and the secondary power arrangement.

8. The trailer of claim 7, wherein the secondary power arrangement comprises at least one of a solar panel, a generator set, and a fuel cell.

9. The trailer of claim 1, wherein the trailer comprises wheels and at least one traction motor configured to power the wheels.

10. The trailer of claim 1, further comprising a hotel module in electrical contact with the trailer battery, wherein the hotel module is configured to provide electrical power from the trailer battery to at least one other electrical component.

11. The trailer of claim 1, wherein the trailer is a refrigerated trailer with a cooling system, and the trailer battery is arranged to provide electrical power to the cooling system.

12. The trailer of claim 1, further comprising a trailer control module arranged to control the trailer when the trailer is not connected to the tractor unit.

13. A tractor unit comprising an electric or hybrid electric powertrain and a control system for controlling the powertrain, wherein tractor unit is arranged to be connected to a trailer comprising a trailer battery, the control system comprises a control module arranged to provide signals for controlling the trailer battery, and the control module is arranged to manage flow of power between the trailer battery and the powertrain.

14. The tractor unit of claim 13, wherein the control module is arranged to receive a signal indicating a state of charge of the trailer battery and to manage flow of power between the trailer battery and the powertrain based on the state of charge.

15. The tractor unit of claim 14, wherein the tractor unit comprises a tractor battery, and the control module is arranged to manage flow of power between the trailer battery, the tractor battery and the powertrain based on a state of charge of the trailer battery and the tractor battery.

16. The tractor unit of claim 15, wherein the control module is arranged to control a regenerative braking split between the tractor battery and the trailer battery.

17. The tractor unit of claim 13, further comprising a connector for removably connecting the trailer battery to the tractor unit.

18. The tractor unit of claim 17, wherein the connector is configured to provide an electrical connection and a fluid connection between the tractor unit and the trailer battery.

19. The tractor unit of claim 13, further comprising a sensor configured to sense when the trailer battery is connected to the powertrain, wherein the control module is arranged to manage flow of power between the trailer battery and the powertrain when it is sensed that the trailer battery is connected.

20. A method of operating a truck comprising a tractor unit and a trailer, the tractor unit comprising an electric or hybrid electric powertrain and a control system for controlling the powertrain, the trailer comprising a trailer battery, and the control system comprising a control module, the method comprising providing control signals from the control module to the trailer battery to control provision of power from the trailer battery to the powertrain.

21. A trailer, comprising:
a trailer battery arranged to provide power to a trailer refrigeration system; and
a battery management system arranged to receive a control signal from a temperature control unit and to control the trailer refrigeration system powered by the trailer battery;
wherein the trailer refrigeration system has a refrigeration control unit, an electric compressor, and an inverter;
wherein the trailer battery is arranged to provide power to the trailer refrigeration system and the refrigeration control unit is arranged to control a supply of power from the battery to the trailer refrigeration system.

22. The trailer of claim 21, wherein the battery management system is arranged to send a message to a vehicle computing system when the trailer battery has low power.
